(19) United States
(12) Patent Application Publication
(10) Pub. No.: US 2025/0348122 A1
(43) Pub. Date: Nov. 13, 2025

(54) IMAGE DISPLAY APPARATUS

(71) Applicant: LG ELECTRONICS INC., Seoul (KR)

(72) Inventor: Sangmo KIM, Seoul (KR)

(73) Assignee: LG ELECTRONICS INC., Seoul (KR)

(21) Appl. No.: 19/200,245

(22) Filed: May 6, 2025

(30) Foreign Application Priority Data
May 7, 2024 (WO) PCT/KR2024/006085

(51) Int. Cl. G06F 1/26; G06F 3/14; G09G 5/00

(52) U.S. Cl. CPC G06F 1/263; G06F 3/14; G09G 5/006; G09G 2330/021

(57) ABSTRACT

An image display apparatus according to an embodiment of the present disclosure comprises: a display; an interface electrically connected to an external battery device or a mobile terminal; a power controller to control a source mode or a sink mode of the interface; an internal battery; and a power circuit device including a DC voltage input terminal, and the power controller is configured to receive first DC voltage through the interface in the case in which DC voltage is not supplied in the sink mode, and supply third DC voltage based on the source mode in the case in which second DC voltage is supplied through the DC voltage input terminal. Accordingly, it is possible to perform a source mode operation for supplying the DC voltage to the external battery device or the mobile terminal.

### CROSS-REFERENCE TO RELATED APPLICATION(S)

Pursuant to 35 U.S.C. § 119, this application claims the benefit of earlier filing date and right of priority to International Application No. PCT/KR2024/006085, filed on May 7, 2024, the contents of which are all incorporated by reference herein in its entirety.

### BACKGROUND

### 1. Field

The present disclosure relates to an image display apparatus, and more particularly, to an image display apparatus which may perform a source mode operation for supplying direct current (DC) voltage to an external battery device or a mobile terminal.

### 2. Description of the Related Art

An image display apparatus is an apparatus that displays an image through a display.

Meanwhile, the image display apparatus may be configured to receive DC voltage through an interface connected by an external battery device.

Meanwhile, in the case in which a battery is provided in the image display apparatus, DC voltage supplied from a DC power supply terminal or DC voltage through the interface can be received for battery charging.

Meanwhile, since the interface in the image display apparatus can operate only in a sink mode, the DC voltage is received only through the interface, and in the case in which charging an external battery device is required, there is a disadvantage in that the DC voltage cannot be supplied through the interface.

### SUMMARY

An object of the present disclosure is to provide an image display apparatus which may perform a source mode operation for supplying direct current (DC) voltage to an external battery device or a mobile terminal.

Another object of the present disclosure is to provide an image display apparatus which can easily charge an internal battery through a sink mode.

In accordance with an embodiment of the present disclosure, an image display apparatus includes: a display; an interface electrically connected to an external battery device or a mobile terminal; a power controller configured to control a source mode or a sink mode of the interface; an internal battery; and a power circuit device including a DC voltage input terminal, and configured to control a charging mode or a discharging mode of the internal battery, and the power controller is configured to receive first DC voltage from the battery device or the mobile terminal through the interface in the case in which DC voltage is not supplied through the DC voltage input terminal in the sink mode, and supply third DC voltage to the battery device or the mobile terminal through the interface based on the source mode in the case in which second DC voltage is supplied through the DC voltage input terminal.

Meanwhile, the power controller may be configured to stop reception of the first DC voltage through the interface in the case in which the second DC voltage is supplied through the DC voltage input terminal in the sink mode.

Meanwhile, the power controller may be configured to stop the supply of the third DC voltage through the interface in the case in which the supply of the second DC voltage is stopped through the DC voltage input terminal during operating in the source mode.

Meanwhile, the power circuit device may be configured to supply current corresponding to the second DC voltage to the internal battery in the case in which the second DC voltage is supplied through the DC voltage input terminal.

Meanwhile, the power controller may be configured to receive current of a first level, or receive current of a second level higher than the first level, from the battery device or the mobile terminal through the interface in the sink mode based on voltage information or current information of the battery device or the mobile terminal received through the interface.

Meanwhile, the power circuit device may be configured to supply the current of the first level or the current of the second level from the interface to the internal battery in the sink mode.

Meanwhile, the power controller may be configured to supply current of a third level lower than the first level to the battery device or the mobile terminal through the interface in the source mode.

Meanwhile, the image display apparatus according to an embodiment of the present disclosure may further include a signal processing device configured to output an image signal to the display, and the interface may be configured to transmit the image signal received from the mobile terminal to the signal processing device or the power controller based on a display mode.

Meanwhile, the interface may be configured to continuously transmit the image signal received from the mobile terminal to the signal processing device or the power controller in the case in which the second DC voltage is supplied through the DC voltage input terminal during operating in the display mode.

Meanwhile, the interface may include a first port to receive the first DC voltage in the sink mode, or output the third DC voltage to the outside in the source mode, and a second port to receive the voltage information of the battery device or the mobile terminal.

Meanwhile, the image display apparatus according to an embodiment of the present disclosure may further include a load switch electrically connected to the first port, and the load switch may be turned off in the sink mode, and turned on in the source mode, and may be configured to supply the third DC voltage to the first port.

Meanwhile, the interface may be configured to supply the first DC voltage received through the first port to the power circuit device in the sink mode.

Meanwhile, the image display apparatus according to an embodiment of the present disclosure may further include a dc/dc converter electrically connected to the first port, and the dc/dc converter may be configured to decrease a level of the first DC voltage received through the first port, and supply the decreased DC voltage to the power controller.

Meanwhile, the image display apparatus according to an embodiment of the present disclosure may further include a signal processing device configured to output a mode change message in the case in which the second DC voltage is supplied through the DC voltage input terminal during the sink mode operation, and the power controller may be configured to switch the sink mode to the source mode based on the mode change message.

Meanwhile, the image display apparatus according to an embodiment of the present disclosure may further include a load switch electrically connected to the interface, and the power controller may be configured to supply the third DC voltage to the interface through the load switch by turning on the load switch based on the mode change message.

In accordance with another embodiment of the present disclosure, an image display apparatus includes: a display; an interface electrically connected to an external battery device or a mobile terminal; a power controller configured to control a source mode or a sink mode of the interface; and a DC voltage input terminal, and the power controller is configured to receive first DC voltage from the battery device or the mobile terminal through the interface in the sink mode, and stop the reception of the first DC voltage through the interface in the case in which second DC voltage is supplied through the DC voltage input terminal during operating in the sink mode, and supply third DC voltage to the battery device or the mobile terminal through the interface by switching the sink mode to the source mode.

Meanwhile, the image display apparatus according to another embodiment of the present disclosure may further include signal processing device configured to output a mode change message in the case in which the second DC voltage is supplied through the DC voltage input terminal during the sink mode operation, and the power controller may be configured to switch the sink mode to the source mode based on the mode change message.

Meanwhile, the image display apparatus according to another embodiment of the present disclosure may further include a load switch electrically connected to the interface, and the power controller may be configured to supply the third DC voltage to the interface through the load switch by turning on the load switch based on the mode change message.

Meanwhile, in accordance with yet another embodiment of the present disclosure, an image display apparatus includes: a display; an interface electrically connected to an external device; a power controller configured to determine an operation mode of a source mode, a sink mode, or a display mode in response to the external device being connected to the interface; a signal processing device configured to output an image signal to the display; a resistor between the power controller and the signal processing device; and a DC voltage input terminal, and in response to a DC voltage being supplied through the DC voltage input terminal, the power controller is configured to output a high-level signal to the resistor, and operate in the source mode based on the high-level signal.

Meanwhile, the power controller may be configured to control the interface to operate in the sink mode in response to the supply of the third DC voltage being stopped through the DC voltage input terminal while the interface operates in the source mode.

### BRIEF DESCRIPTION OF THE DRA WINGS

The above and other objects, features and other advantages of the present disclosure will be more clearly understood from the following detailed description taken in conjunction with the accompanying drawings, in which:

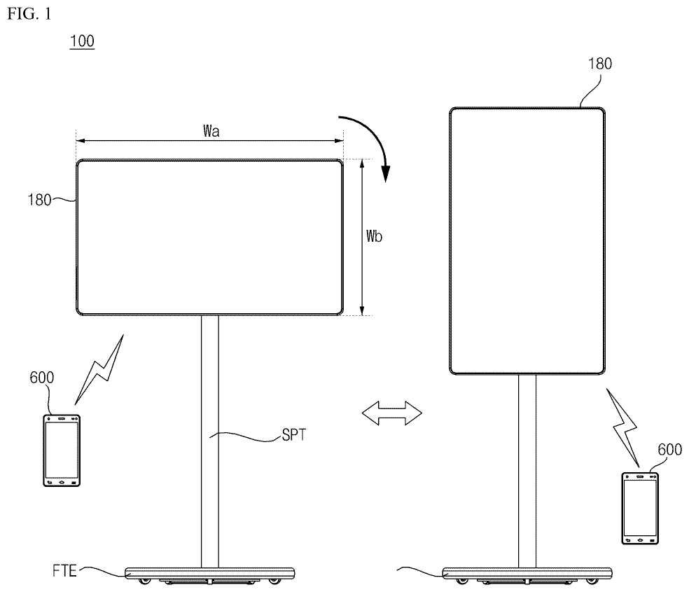

FIG. 1 is a diagram showing an image display apparatus according to an embodiment of the present disclosure;

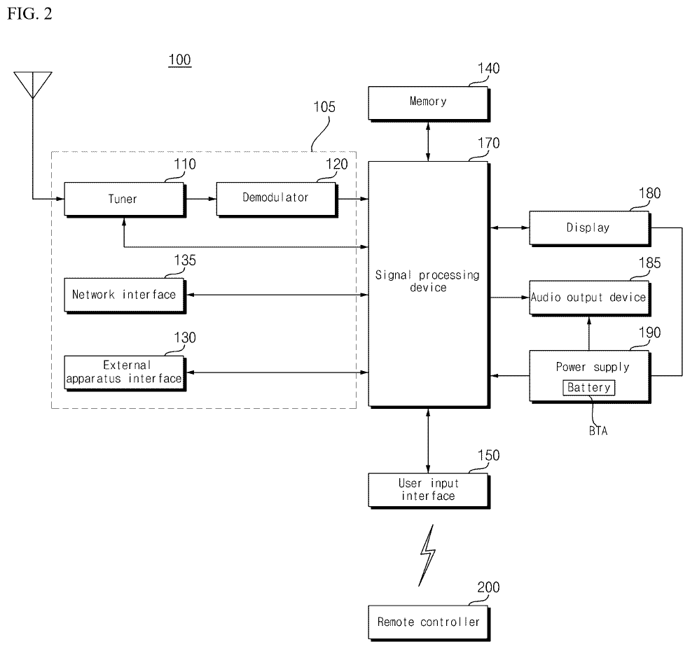

FIG. 2 is an example of an internal block diagram of the image display apparatus;

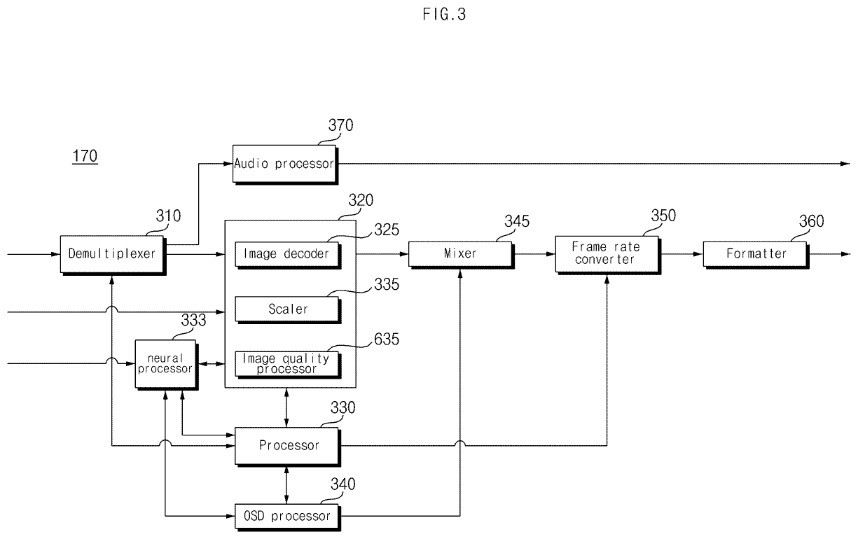

FIG. 3 is an example of an internal block diagram of a signal processing device of FIG. 2;

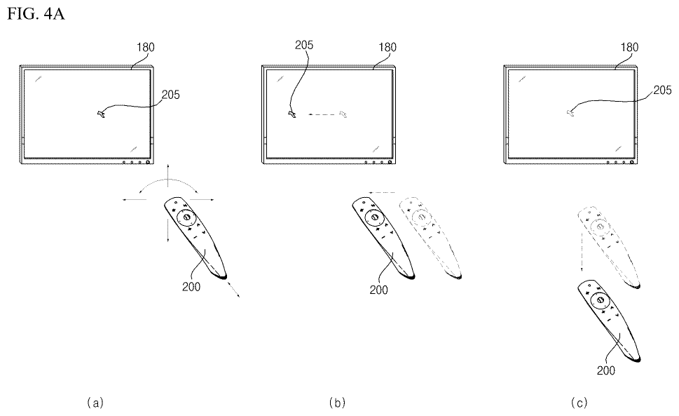

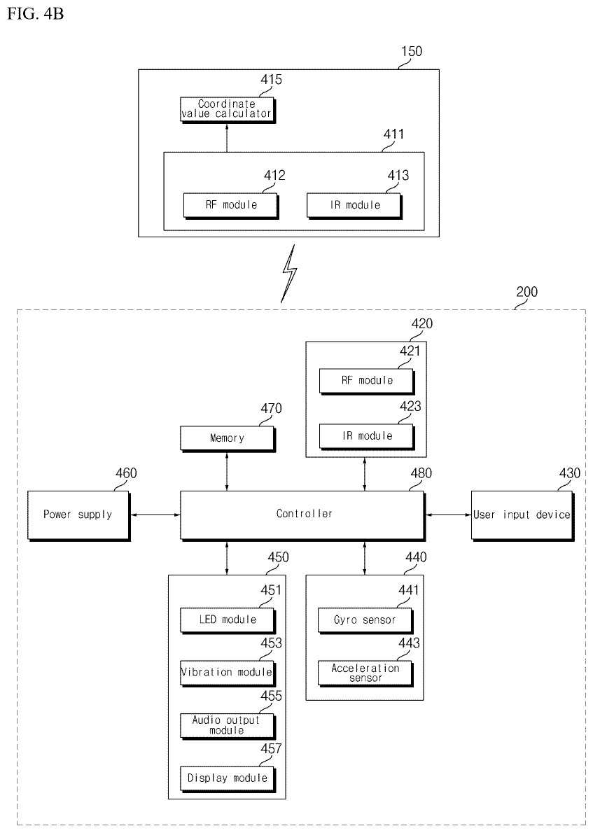

FIG. 4A is a diagram showing a method of controlling a remote controller of FIG. 2;

FIG. 4B is an internal block diagram of the remote controller of FIG. 2;

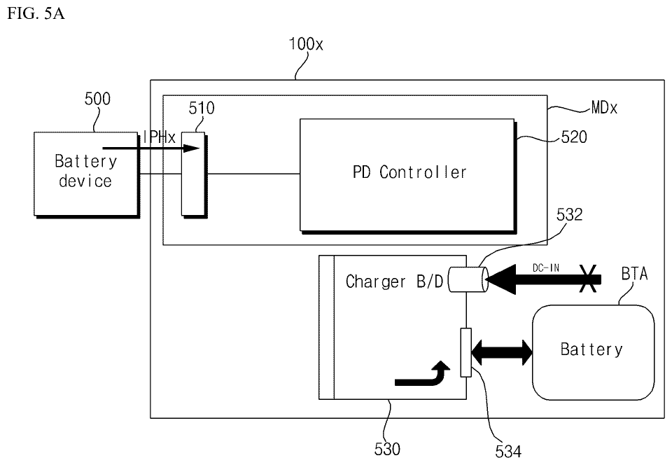

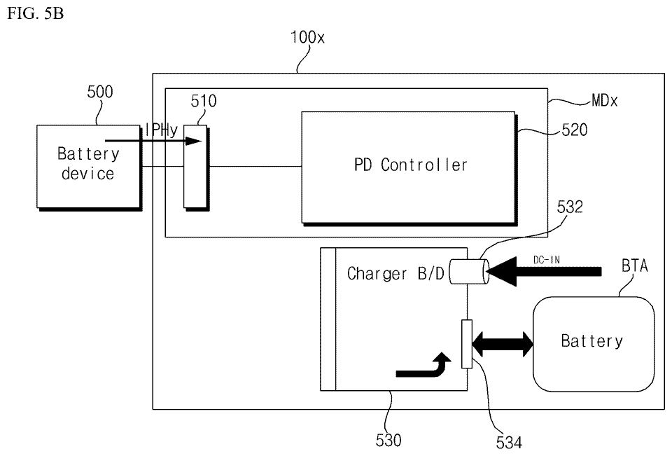

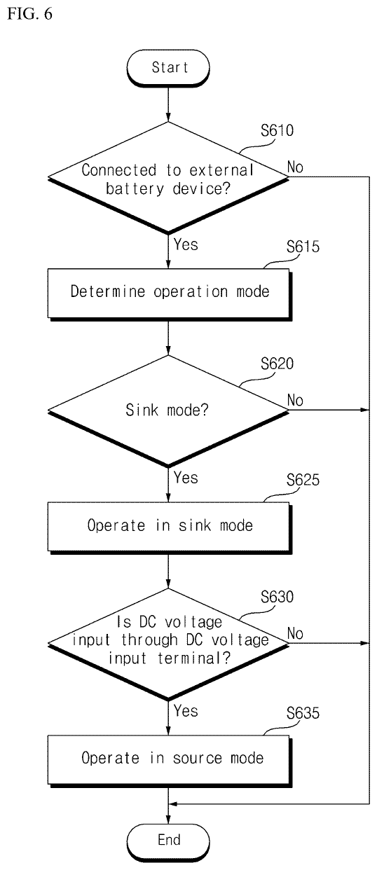

FIGS. 5A to 5B are diagrams describing an operation of an image display apparatus according to the present disclosure;

FIG. 6 is a flowchart illustrating an operation method of the image display apparatus according to an embodiment of the present disclosure;

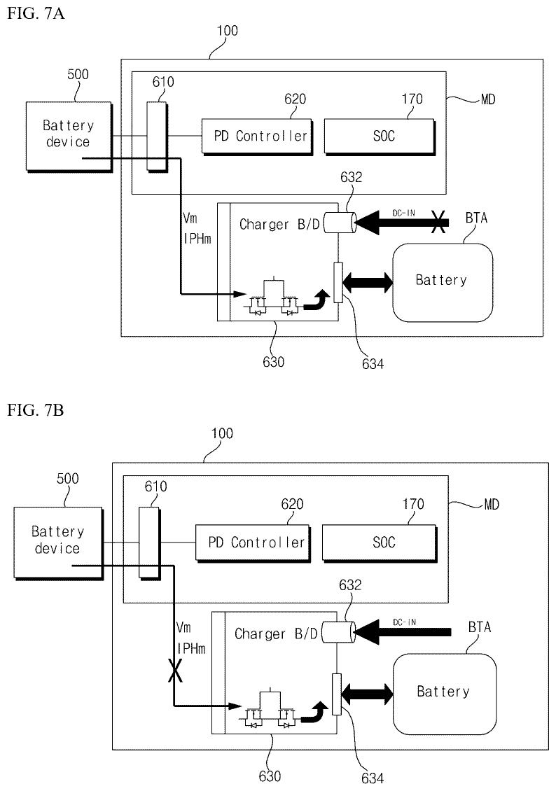

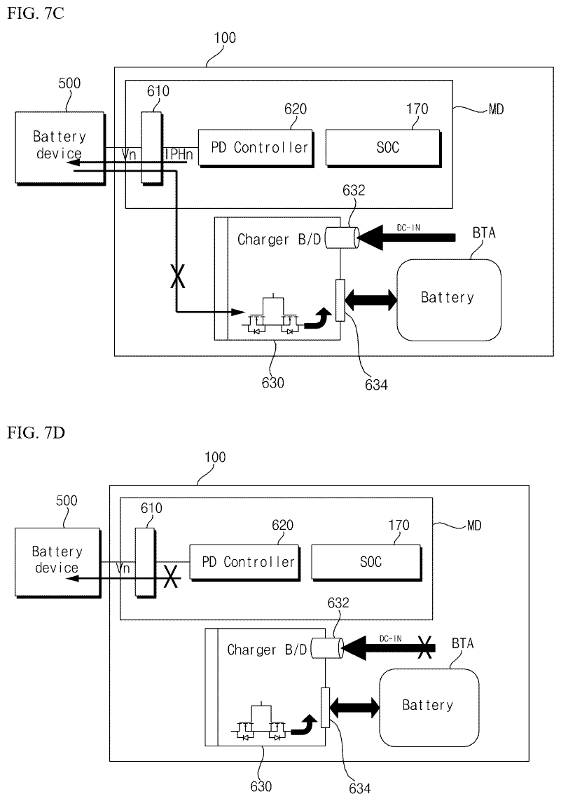

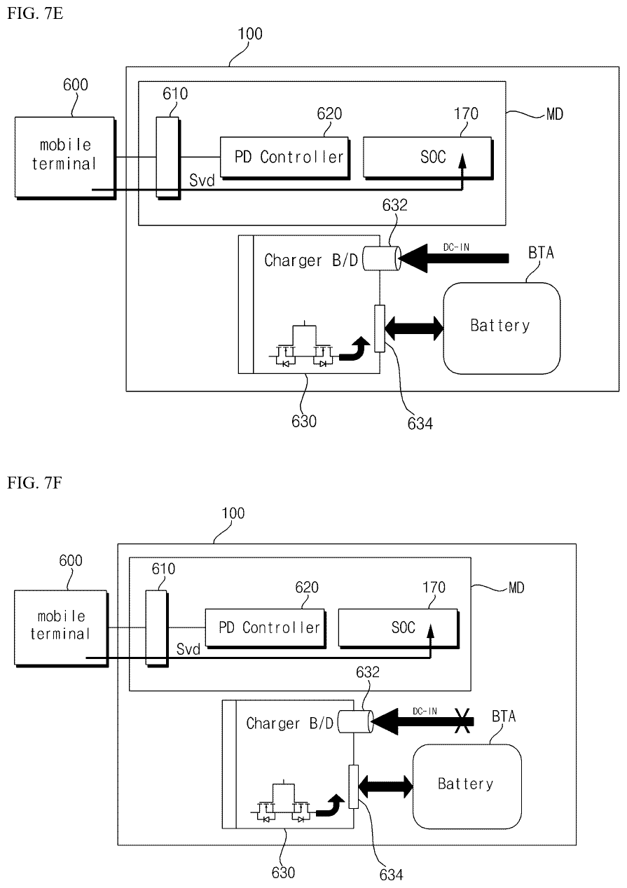

FIGS. 7A to 7F are diagrams referred to for description of an operation of FIG. 6;

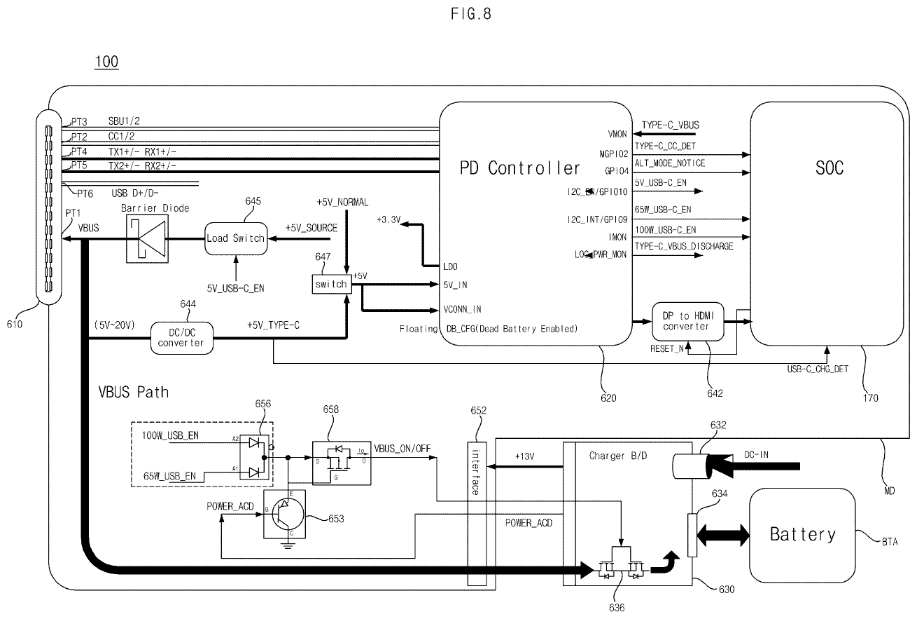

FIG. 8 illustrates an example of an internal block diagram of an image display apparatus according to an embodiment of the present disclosure; and

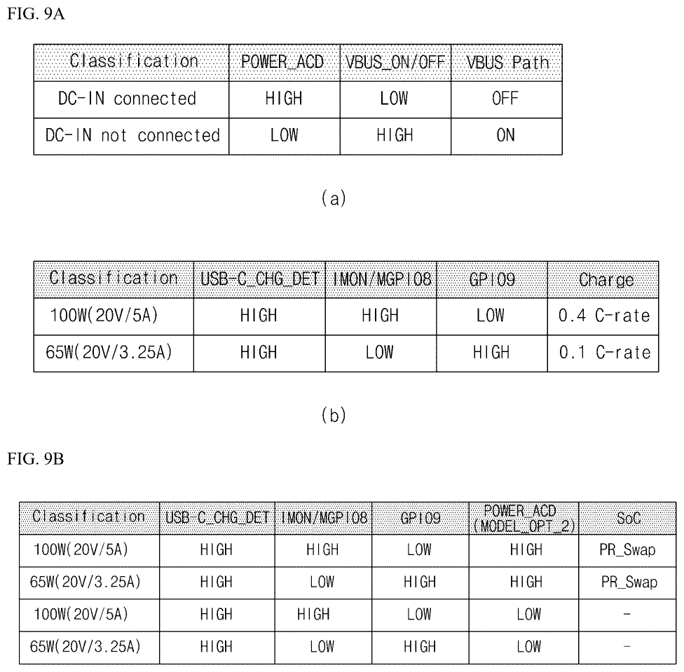

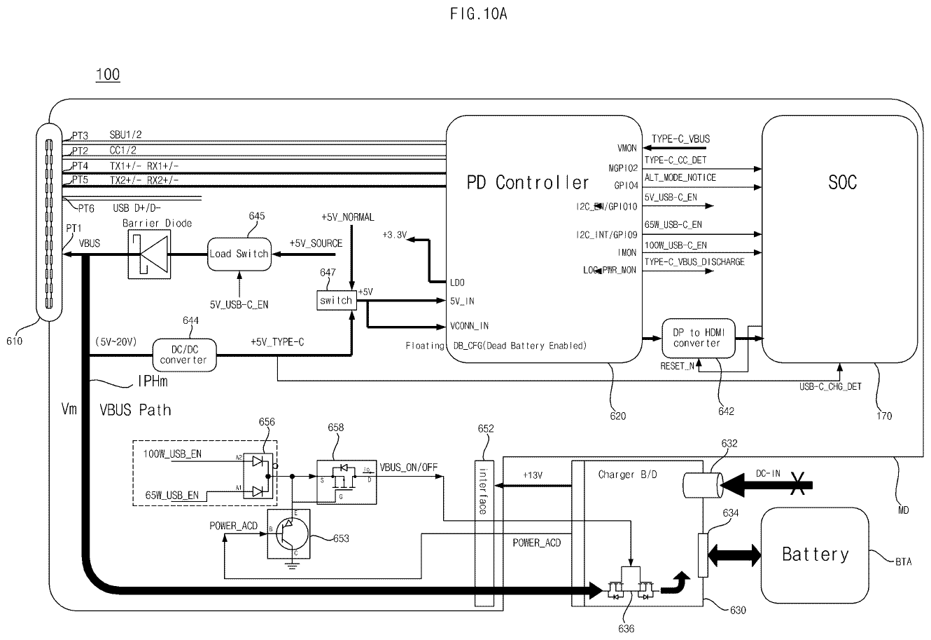

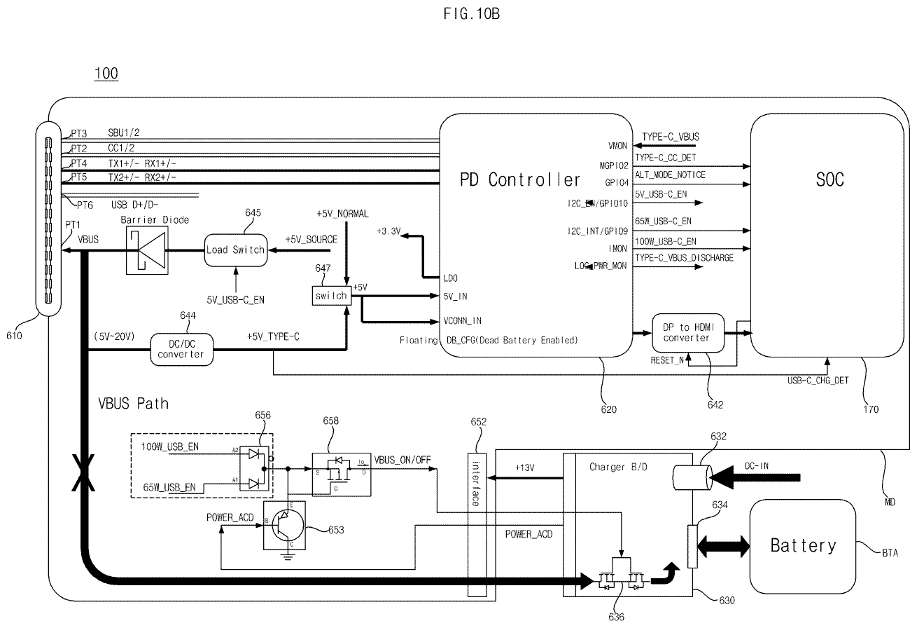

FIGS. 9A to 10CF are diagrams referred to for description of the operation of FIG. 8.

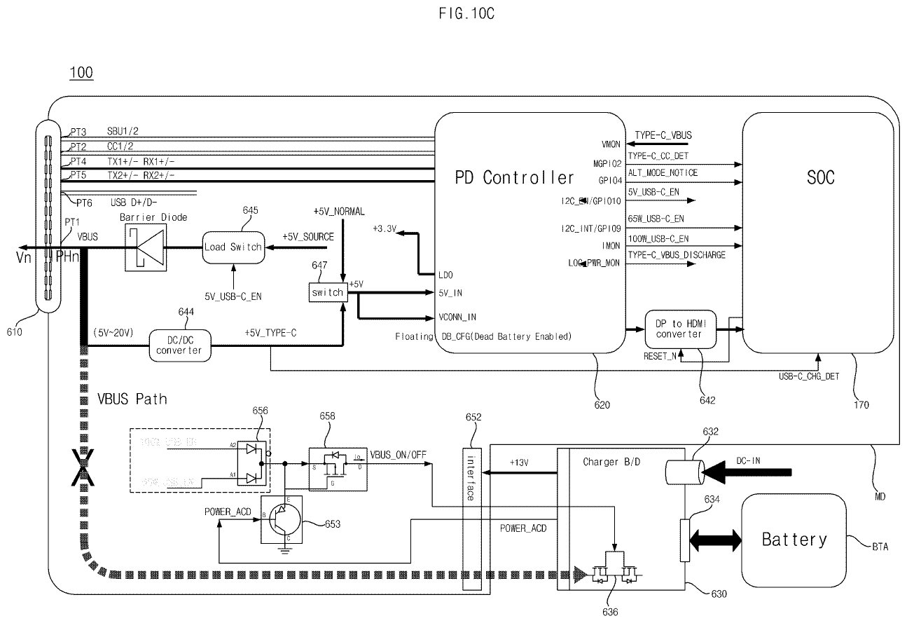

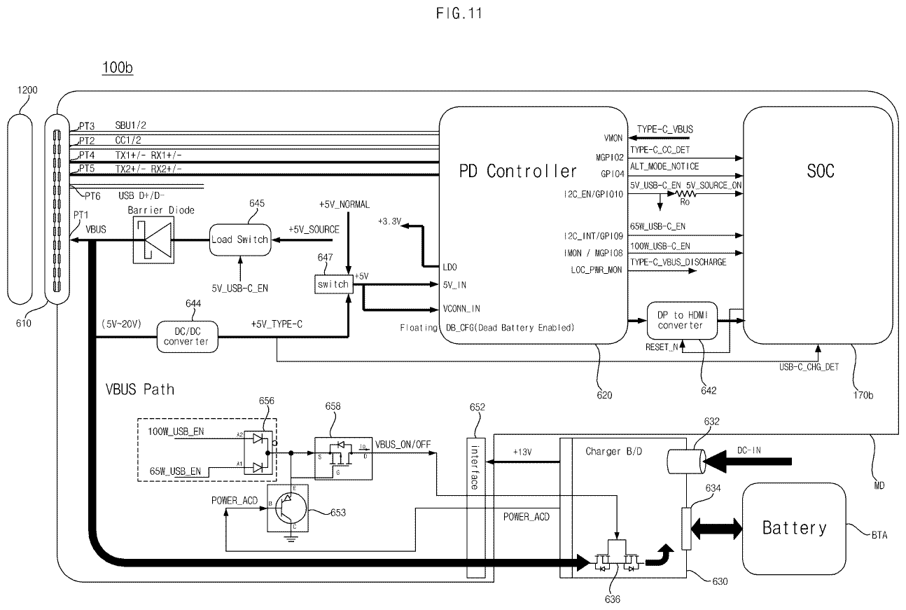

FIG. 11 illustrates an example of an internal block diagram of an image display apparatus according to another embodiment of the present disclosure;

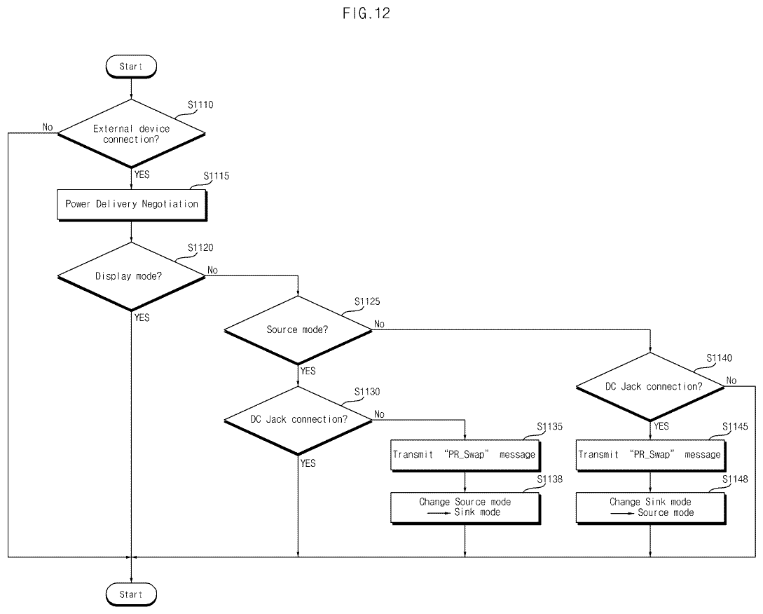

FIG. 12 illustrates an example of a flowchart illustrating an operation method of the image display apparatus of FIG. 11; and

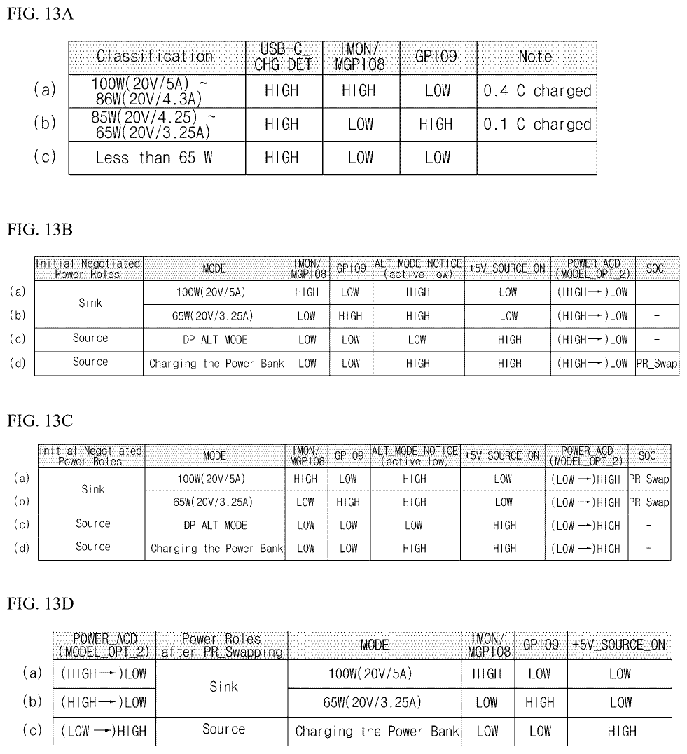

FIGS. 13A to 13D are diagrams referred to for description of the operation of FIG. 11 or 12.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” may be used interchangeably.

FIG. 1 is a diagram showing an image display apparatus according to an embodiment of the present disclosure.

Referring to FIG. 1, an image display apparatus 100 according to an embodiment of the present disclosure comprises a display 180.

Meanwhile, the image display apparatus 100 may further include a base FTE, and a support frame SPT supporting between the base FTE and the display 180.

Meanwhile, the image display apparatus 100 may be a movable image display apparatus.

For example, at least one wheel is disposed below the base FTE to operate in the case in which the image display apparatus 100 moves.

Meanwhile, the display 180 in the image display apparatus 100 according to an embodiment of the present disclosure may be rotatable.

For example, the display 180 in the image display apparatus 100 rotates in a horizontal mode in which a screen ratio is Wa:Wb, which may be switched to a vertical mode in which the screen ratio is Wb:Wa.

As another example, the display 180 in the image display apparatus 100 rotates in the vertical mode in which the screen ratio is Wb:Wa, which may be switched to the horizontal mode in which the screen ratio is Wa:Wb.

Meanwhile, the image display apparatus 100 according to an exemplary embodiment of the present disclosure may be wiredly connected or wirelessly connected to an external battery device 500 or a peripheral electronic device such as a mobile terminal 600, etc.

For example, the image display apparatus 100 according to an exemplary embodiment of the present disclosure may be configured to receive an image signal from the mobile terminal 600, etc.

Meanwhile, the image display apparatus 100 according to an exemplary embodiment of the present disclosure comprises a battery BTA of FIG. 2.

Meanwhile, a power supply 190 of FIG. 2 in the image display apparatus 100 supplies charging current to the battery BTA to charge the battery BTA upon a charging mode of the battery BTA.

Meanwhile, the image display apparatus 100 of FIG. 1 may be a TV, a monitor, etc.

FIG. 2 is an example of an internal block diagram of the image display apparatus of FIG. 1.

Referring to FIG. 2, the image display apparatus 100 according to an embodiment of the present disclosure comprises an image receiver 105, an external apparatus interface 130, a memory 140, a user input interface 150, a sensor device (not shown), a signal processing device 170, a display 180, and an audio output device 185.

The image receiver 105 may include a tuner 110, a demodulator 120, a network interface 135, and an external apparatus interface 130.

Meanwhile, unlike the figure, the image receiver 105 may include only the tuner 110, the demodulator 120, and the external apparatus interface 130. That is, the network interface 135 may not be included.

The tuner 110 selects an RF broadcast signal corresponding to a channel selected by a user or all pre-stored channels among radio frequency (RF) broadcast signals received through an antenna (not shown). In addition, the selected RF broadcast signal is converted into an intermediate frequency signal, a baseband image, or an audio signal.

For example, the tuner 110 converts the selected RF broadcasting signal into a digital IF signal (DIF) in the case in which the selected RF broadcasting signal is a digital broadcasting signal, and converts the selected RF broadcasting signal into an analog baseband image or voice signal (CVBS/SIF) in the case in which the selected RF broadcasting signal is an analog broadcasting signal. That is, the tuner 110 may process the digital broadcasting signal or the analog broadcasting signal. The analog baseband image or voice signal outputted from the tuner 110 may be directly inputted into the signal processing device 170.

Meanwhile, the tuner 110 may include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may perform demodulation and channel decoding and then output a stream signal TS. At this time, the stream signal may be a multiplexed signal of an image signal, an audio signal, or a data signal.

The stream signal output from the demodulator 120 may be input to the signal processing device 170. The signal processing device 170 performs demultiplexing, image/audio signal processing, and the like, and then outputs an image to the display 180 and outputs audio to the audio output device 185.

The external apparatus interface 130 may be configured to transmit or receive data with a connected external apparatus (not shown), e.g., a set-top box 50. To this end, the external apparatus interface 130 may include an A/V input and output device (not shown).

The external apparatus interface 130 may be connected in wired or wirelessly to an external apparatus, such as a digital versatile disk (DVD), a Blu ray, a game equipment, a camera, a camcorder, a computer (note book), and a set-top box, and may perform an input/output operation with an external apparatus.

The A/V input and output device may be configured to receive image and audio signals from an external apparatus. Meanwhile, a wireless transceiver (not shown) may perform short-range wireless communication with other electronic apparatus.

Through the wireless transceiver (not shown), the external apparatus interface 130 may exchange data with an adjacent mobile terminal 600. In particular, in a mirroring mode, the external apparatus interface 130 may be configured to receive device information, executed application information, application image, and the like from the mobile terminal 600.

The network interface 135 provides an interface for connecting the image display apparatus 100 to a wired/wireless network including the Internet network. For example, the network interface 135 may be configured to receive, via the network, content or data provided by the Internet, a content provider, or a network operator.

Meanwhile, the network interface 135 may include a wireless transceiver (not shown).

The memory 140 may store a program for each signal processing and control in the signal processing device 170, and may store signal-processed image, audio, or data signal.

In addition, the memory 140 may serve to temporarily store image, audio, or data signal input to the external apparatus interface 130. In addition, the memory 140 may store information on a certain broadcast channel through a channel memory function, such as a channel map.

Although FIG. 2 illustrates that the memory is provided separately from the signal processing device 170, the scope of the present disclosure is not limited thereto. The memory 140 may be included in the signal processing device 170.

The user input interface 150 transmits a signal input by the user to the signal processing device 170 or transmits a signal from the signal processing device 170 to the user.

For example, it may be configured to transmit/receive a user input signal, such as power on/off, channel selection, screen setting, etc., from a remote controller 200, may transfer a user input signal input from a local key (not shown), such as a power key, a channel key, a volume key, a set value, etc., to the signal processing device 170, may transfer a user input signal input from a sensor device (not shown) that senses a user's gesture to the signal processing device 170, or may be configured to transmit a signal from the signal processing device 170 to the sensor device (not shown).

The signal processing device 170 may demultiplex the input stream through the tuner 110, the demodulator 120, the network interface 135, or the external apparatus interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and may be displayed as an image corresponding to the image signal. In addition, the image signal processed by the signal processing device 170 may be input to the external output apparatus through the external apparatus interface 130.

The audio signal processed by the signal processing device 170 may be output to the audio output device 185 as an audio signal. In addition, audio signal processed by the signal processing device 170 may be input to the external output apparatus through the external apparatus interface 130.

Although not shown in FIG. 2, the signal processing device 170 may include a demultiplexer, an image processor, and the like. That is, the signal processing device 170 may perform a variety of signal processing and thus it may be implemented in the form of a system on chip (SOC). This will be described later with reference to FIG. 3.

In addition, the signal processing device 170 may control the overall operation of the image display apparatus 100. For example, the signal processing device 170 may control the tuner 110 to control the tuning of the RF broadcast corresponding to the channel selected by the user or the previously stored channel.

In addition, the signal processing device 170 may control the image display apparatus 100 according to a user command input through the user input interface 150 or an internal program.

Meanwhile, the signal processing device 170 may control the display 180 to display an image. At this time, the image displayed on the display 180 may be a still image or a moving image, and may be a 2D image or a 3D image.

Meanwhile, the signal processing device 170 may display a certain object in an image displayed on the display 180. For example, the object may be at least one of a connected web screen (newspaper, magazine, etc.), an electronic program guide (EPG), various menus, a widget, an icon, a still image, a moving image, and a text.

Meanwhile, the signal processing device 170 may recognize the position of the user based on the image photographed by a photographing device (not shown). For example, the distance (z-axis coordinate) between a user and the image display apparatus 100 may be determined. In addition, the x-axis coordinate and the y-axis coordinate in the display 180 corresponding to a user position may be determined.

The display 180 generates a driving signal by converting an image signal, a data signal, an OSD signal, a control signal processed by the signal processing device 170, an image signal, a data signal, a control signal, and the like received from the external apparatus interface 130.

Meanwhile, the display 180 may be configured as a touch screen and used as an input device in addition to an output device.

The audio output device 185 receives a signal processed by the signal processing device 170 and outputs it as an audio.

The photographing device (not shown) photographs a user. The photographing device (not shown) may be implemented by a single camera, but the present disclosure is not limited thereto and may be implemented by a plurality of cameras. Image information photographed by the photographing device (not shown) may be input to the signal processing device 170.

The signal processing device 170 may sense a gesture of the user based on each of the images photographed by the photographing device (not shown), the signals detected from the sensor device (not shown), or a combination thereof.

The power supply 190 supplies corresponding power to the image display apparatus 100.

Particularly, the power may be supplied to a signal processing device 170 which may be implemented in the form of a system on chip (SOC), a display 180 for displaying an image, and an audio output device 185 for outputting an audio.

Specifically, the power supply 190 may include a converter to convert the level of the input voltage.

For example, the power supply 190 may include an ac/dc converter and a dc/dc converter in the case in which the input voltage is an alternating current voltage.

As another example, the power supply 190 may include the dc/dc converter in the case in which the input voltage is a direct current voltage.

Meanwhile, the power supply 190 includes the battery BTA.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may be configured to receive the image, audio, or data signal output from the user input interface 150, and display it on the remote controller 200 or output it as an audio.

Meanwhile, the image display apparatus 100 may be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to the figure, the signal processing device 170 according to an embodiment of the present disclosure may include a demultiplexer 310, an image processor 320, a processor 330, and an audio processor 370. In addition, the signal processing device 170 may further include and a data processor (not shown).

The demultiplexer 310 demultiplexes the input stream. For example, in the case in which an MPEG-2 TS is input, it may be demultiplexed into image, audio, and data signal, respectively. Here, the stream signal input to the demultiplexer 310 may be a stream signal output from the tuner 110, the demodulator 120, or the external apparatus interface 130.

The image processor 320 may perform signal processing on an input image. For example, the image processor 320 may perform image processing on an image signal demultiplexed by the demultiplexer 310.

To this end, the image processor 320 may include an image decoder 325, a scaler 335, an image quality processor 635, an image encoder (not shown), a graphic processor 340, a frame rate converter 350, a formatter 360, etc.

The image decoder 325 decodes a demultiplexed image signal, and the scaler 335 performs scaling so that the resolution of the decoded image signal may be output from the display 180.

The image decoder 325 may include a decoder of various standards. For example, a 3D image decoder for MPEG-2, H.264 decoder, a color image, and a depth image, and a decoder for a multiple view image may be provided.

The scaler 335 may scale an input image signal decoded by the image decoder 325 or the like.

For example, if the size or resolution of an input image signal is small, the scaler 335 may upscale the input image signal, and, if the size or resolution of the input image signal is great, the scaler 335 may downscale the input image signal.

The image quality processor 635 may perform image quality processing on an input image signal decoded by the image decoder 325 or the like.

For example, the image quality processor 625 may perform noise reduction processing on an input image signal, extend a resolution of high gray level of the input image signal, perform image resolution enhancement, perform high dynamic range (HDR)-based signal processing, change a frame rate, perform image quality processing suitable for properties of a panel, especially an OLED panel, etc.

The graphic processor 340 generates an OSD signal according to a user input or by itself. For example, based on a user input signal, the graphic processor 340 may generate a signal for displaying various information as a graphic or a text on the screen of the display 180. The generated OSD signal may include various data, such as a user interface screen of the image display apparatus 100, various menu screens, a widget, and an icon. In addition, the generated OSD signal may include a 2D object or a 3D object.

In addition, the graphic processor 340 may generate a pointer that may be displayed on the display, based on a pointing signal input from the remote controller 200. In particular, such a pointer may be generated by a pointing signal processing device, and the graphic processor 340 may include such a pointing signal processing device (not shown). Obviously, the pointing signal processing device (not shown) may be provided separately from the graphic processor 340.

The frame rate converter (FRC) 350 may convert a frame rate of an input image. Meanwhile, the frame rate converter 350 may output the input image without converting the frame rate.

Meanwhile, the formatter 360 may change a format of an input image signal into a format suitable for displaying the image signal on a display and output the image signal in the changed format.

In particular, the formatter 360 may change a format of an image signal to correspond to a display panel.

Meanwhile, the formatter 360 may also change the format of the video signal.

The processor 330 may control overall operations of the image display apparatus 100 or the signal processing device 170.

For example, the processor 330 may control the tuner 110 to control the tuning of an RF broadcast corresponding to a channel selected by a user or a previously stored channel.

In addition, the processor 330 may control the image display apparatus 100 according to a user command input through the user input interface 150 or an internal program.

In addition, the processor 330 may be configured to transmit data to the network interface 135 or to the external apparatus interface 130.

In addition, the processor 330 may control the demultiplexer 310, the image processor 320, and the like in the signal processing device 170.

Meanwhile, the audio processor 370 in the signal processing device 170 may perform the audio processing of the demultiplexed audio signal. To this end, the audio processor 370 may include various decoders.

In addition, the audio processor 370 in the signal processing device 170 may process a base, a treble, a volume control, and the like.

The data processor (not shown) in the signal processing device 170 may perform data processing of the demultiplexed data signal. For example, in the case in which the demultiplexed data signal is a coded data signal, it may be decoded. The encoded data signal may be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may be provided separately in addition to the image processor 320.

Meanwhile, the signal processing device 170 according to an exemplary embodiment of the present disclosure may further include a neural network processor 333 for learning processing, etc.

FIG. 4A is a diagram illustrating a control method of a remote controller of FIG. 2.

As shown in FIG. 4A (a), it is illustrated that a pointer 205 corresponding to the remote controller 200 is displayed on the display 180.

The user may move or rotate the remote controller 200 up and down, left and right (FIG. 4A (b)), and back and forth (FIG. 4A (c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the figure.

FIG. 4A (b) illustrates that in the case in which the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A (c) illustrates a case where the user moves the remote controller 200 away from the display 180, while pressing a specific button of the remote controller 200. Thus, a selection area within the display 180 corresponding to the pointer 205 may be zoomed in so that it may be displayed to be enlarged. Meanwhile, in the case in which the user moves the remote controller 200 close to the display 180, the selection area within the display 180 corresponding to the pointer 205 may be zoomed out so that it may be displayed to be reduced. Meanwhile, in the case in which the remote controller 200 moves away from the display 180, the selection area may be zoomed out, and in the case in which the remote controller 200 approaches the display 180, the selection area may be zoomed in.

Meanwhile, in the case in which the specific button of the remote controller 200 is pressed, it is possible to exclude the recognition of vertical and lateral movement. That is, in the case in which the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

Meanwhile, the moving speed or the moving direction of the pointer 205 may correspond to the moving speed or the moving direction of the remote controller 200.

FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may be configured to receive the signal transmitted by the image display apparatus 100 through the RF module 421. In addition, if necessary, the remote controller 200 may be configured to transmit a command related to power on/off, channel change, volume change, and the like to the image display apparatus 100 through the IR module 423.

The user input device 435 may be implemented by a keypad, a button, a touch pad, a touch screen, or the like. The user may operate the user input device 435 to input a command related to the image display apparatus 100 to the remote controller 200. in the case in which the user input device 435 includes a hard key button, the user may input a command related to the image display apparatus 100 to the remote controller 200 through a push operation of the hard key button. in the case in which the user input device 435 includes a touch screen, the user may touch a soft key of the touch screen to input the command related to the image display apparatus 100 to the remote controller 200. In addition, the user input device 435 may include various types of input means, such as a scroll key, a jog key, etc., which may be operated by the user, and the present disclosure does not limit the scope of the present disclosure.

The sensor device 440 may include a gyro sensor 441 or an acceleration sensor 443. The gyro sensor 441 may sense information regarding the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may output an image or an audio signal corresponding to the operation of the user input device 435 or a signal transmitted from the image display apparatus 100. Through the output device 450, the user may recognize whether the user input device 435 is operated or whether the image display apparatus 100 is controlled.

For example, the output device 450 may include an LED module 451 that is turned on in the case in which the user input device 435 is operated or a signal is transmitted/received to/from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. in the case in which the remote controller 200 is not moved for a certain time, the power supply 460 may stop the supply of power to reduce a power waste. The power supply 460 may resume power supply in the case in which a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information regarding a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may be configured to transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that may wirelessly transmit and receive a signal to and from the remote controller 200 and a coordinate value calculator 415 that may calculate the coordinate value of a pointer corresponding to the operation of the remote controller 200.

The user input interface 150 may wirelessly transmit and receive a signal to and from the remote controller 200 through the RF module 412. In addition, the user input interface 150 may be configured to receive a signal transmitted by the remote controller 200 through the IR module 413 according to a IR communication standard.

The coordinate value calculator 415 may correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may be configured to transmit information on the received pointer coordinate value to the controller 180 without a separate correction process of hand shake or error.

For another example, unlike the figure, the coordinate value calculator 415 may be provided in the signal processing device 170, not in the user input interface 150.

FIGS. 5A to 5B are diagrams describing an operation of an image display apparatus according to the present disclosure.

FIG. 5A illustrates an example of the operation of the image display apparatus according to the present disclosure.

Referring to FIG. 5A, the image display apparatus 100x according to the present disclosure may include an interface 510, a power controller 520, a power circuit device 530, and an internal battery BTA electrically connected to the external battery device 500.

Meanwhile, the interface 510 and the power controller 520 may be mounted on a main circuit board MDx.

Meanwhile, FIG. 5A illustrates that DC voltage DC-IN is not supplied through a DC voltage input terminal 532 in the power circuit device 530.

Meanwhile, the interface 510 may be configured to receive first current IPHx through the interface 510 based on a sink mode.

Meanwhile, the power circuit device 530 may be configured to charge the internal battery BTA based on the first current IPHx input through the interface 510 in a state in which the DC voltage DC-IN is not supplied through the DC voltage input terminal 532.

FIG. 5B illustrates an example of the operation of the image display apparatus according to the present disclosure.

Referring to FIG. 5B, unlike FIG. 5A, FIG. 5B illustrates that DC voltage DC-IN is supplied through the DC voltage input terminal 532.

The image display apparatus 100x according to the present disclosure in FIG. 5B may be configured to charge the internal battery BTA based on second current IPHy input through the interface 510 in the case in which the DC voltage DC-IN is supplied through the DC voltage input terminal 532 during a sink mode operation.

That is, the power circuit device 530 in the drawing may be configured to charge the internal battery BTA based on the second current IPHy input through the interface 510 in the case in which the DC voltage DC-IN is supplied through the DC voltage input terminal 532 during the sink mode operation.

As in FIG. 5B, there is a disadvantage in that DC current or DC voltage may not be supplied to the external battery device 500 through the interface 510 because the sink mode is continuously performed even though the DC voltage DC-IN is supplied through the DC voltage input terminal 532.

Accordingly, the present disclosure proposes a method in which the interface 510 operates in a source mode other than the sink mode. This is described with reference to FIG. 6 or below.

FIG. 6 is a flowchart illustrating an operation method of the image display apparatus according to an embodiment of the present disclosure.

Referring to FIG. 6, the power controller 620 in the image display apparatus 100 according to an embodiment of the present disclosure determines whether the external battery device 500 or the mobile terminal 600 is connected (S610).

For example, the power controller 620 in the image display apparatus 100 may be configured to receive information from the external battery device 500 or the mobile terminal 600 through the interface 610.

The information at this time may include voltage information or current information of the external battery device 500 or the mobile terminal 600.

Specifically, the power controller 620 in the image display apparatus 100 may be configured to receive the voltage information or current information from the external battery device 500 or the mobile terminal 600 through the interface 610, and determine that the external battery device 500 or the mobile terminal 600 is connected based on the voltage information or current information.

Next, the power controller 620 in the image display apparatus 100 according to an embodiment of the present disclosure determines an operation mode of the interface 610 (S615).

For example, the power controller 620 in the image display apparatus 100 may determine to operate in a sink mode for receiving voltage or current from the external battery device 500 or the mobile terminal 600 in the case in which the received voltage information or current information is equal to or higher than a reference level.

As another example, the power controller 620 in the image display apparatus 100 may determine to operate in a source mode for supplying voltage or current to the external battery device 500 or the mobile terminal 600 in the case in which the received voltage information or current information is lower than a second reference level.

The second reference level at this time may be smaller than the reference level, but unlike this, the second reference level may also be equal to the reference level.

Next, the power controller 620 in the image display apparatus 100 according to an embodiment of the present disclosure determines whether the interface 610 is determined to be in the sink mode (S620), and control to operate in the sink mode in the case in which the interface 610 is determined to be in the sink mode (S620).

For example, the power controller 620 is configured to receive first DC voltage (Vm of FIG. 7A) or first DC current (IPHm of FIG. 7A) from the battery device 500 or the mobile terminal 600 through the interface 610 in the case in which the DC voltage is not supplied through the DC voltage input terminal 632 in the sink mode.

Accordingly, the power circuit device 630 may be configured to receive the first DC voltage Vm or the first DC current through the interface 610, and control to charge the internal battery BTA based on the first DC voltage Vm or the first DC current.

That is, the power circuit device 630 may be configured to receive the first DC voltage Vm or the first DC current through the interface 610, and control the internal battery BTA to be charged according to a charging mode based on the first DC voltage Vm or the first DC current. Accordingly, the internal battery BTA may be easily charged through the sink mode.

Next, the power controller 620 or the signal processing device 170 in the image display apparatus 100 according to an embodiment of the present disclosure is configured to determine whether the DC voltage is supplied through the DC voltage input terminal 632 during a sink mode operation (S630), and control the interface 610 to operate in the source mode in the case in which the DC voltage is supplied through the DC voltage input terminal 632 (S635).

For example, the power controller 620 or the signal processing device 170 in the image display apparatus 100 may control reception of the first DC voltage Vm or the first DC current to be stopped through the interface 610 in the case in which second DC voltage DC-IN or second DC current corresponding to the second DC voltage through the DC voltage input terminal 632.

In addition, the power controller 620 or the signal processing device 170 in the image display apparatus 100 may control the source mode to be performed after stopping the reception of the first DC voltage Vm or the first DC current.

That is, the power controller 620 or the signal processing device 170 in the image display apparatus 100 is configured to supply third DC voltage Vn or third DC current corresponding to the third DC voltage to the battery device 500 or the mobile terminal 600 through the interface 610 based on the source mode after the reception of the first DC voltage Vm or the first DC current is stopped. Accordingly, a source mode operation for supplying the DC voltage to the external battery device 500 or the mobile terminal 600 may be performed.

Meanwhile, the power controller 620 or the signal processing device 170 in the image display apparatus 100 may control the supply of the third DC voltage Vn or the third DC current to be stopped through the interface 610 in the case in which the supply of the second DC voltage DC-IN or the second DC current is stopped through the DC voltage input terminal 632 during the source mode operation. Accordingly, in the case in which the supply of the second DC voltage DC-IN or the second DC current is stopped through the DC voltage input terminal 632, the source mode operation may be stopped.

FIGS. 7A to 7F are diagrams referred to for description of an operation of FIG. 6.

FIG. 7A illustrates an example of the sink mode operation of the interface of the image display apparatus according to the embodiment of the present disclosure.

Referring to FIG. 7A, the image display apparatus according to the embodiment of the present disclosure comprises the display 180, the interface 610 electrically connected to the external battery device 500, the power controller 620 controlling the operation of the interface 610, the internal battery BTA, and the power circuit device 630 controlling the charging mode or the discharging mode of the internal battery BTA.

Meanwhile, the image display apparatus 100 according to the embodiment of the present disclosure may further include the signal processing device 170 outputting an image signal.

Meanwhile, the interface 610, the power controller 620, and the signal processing device 170 may be mounted on a main circuit board MD.

Meanwhile, the power circuit device 630 is spaced apart from the main circuit board MD, and includes the DC voltage input terminal 632.

Meanwhile, the power circuit device 630 may further include a second interface 634 that supplies voltage or current to the internal battery BTA in the charging mode of the internal battery BTA, and receives voltage or current in the discharging mode of the internal battery BTA, and a switching device 636 that performs switching to supply the voltage or current from the interface 610 to the second interface 634.

Meanwhile, FIG. 7A illustrates that DC voltage DC-IN is not supplied through the DC voltage input terminal 632 in the power circuit device 630.

Meanwhile, in the case in which the battery device 500 is connected to the power controller 620, the power controller 620 may be configured to receive voltage information or current information of the battery device 500 through the interface 610.

In addition, the power controller 620 may control the interface 610 to operate in the sink mode in the case in which the voltage information or current information of the battery device 500 is equal to or higher than a reference level.

Meanwhile, the power controller 620 is configured to receive first DC voltage Vm or first DC current IPHm corresponding to the first DC voltage Vm through the interface 610 in the case in which second DC voltage DC-IN is not supplied through the DC voltage input terminal 632.

Meanwhile, since the DC voltage D-IN is not supplied through the DC voltage input terminal 632, the interface 610 may be configured to receive the first DC voltage Vm or the first DC current IPHm corresponding to the first DC voltage Vm from the battery device 500 based on the sink mode.

In addition, the power circuit device 630 turns on the switching device 636 to control to charge the internal battery BTA based on the first DC voltage Vm or the first DC current IPHm corresponding to the first DC voltage Vm from the interface 610.

FIG. 7B illustrates another example of the sink mode operation of the interface of the image display apparatus according to the embodiment of the present disclosure.

Referring to FIG. 7B, unlike FIG. 7A, FIG. 7B illustrates that the second DC voltage DC-IN is supplied through the DC voltage input terminal 632 in the power circuit device 630.

Meanwhile, the power controller 620 may be configured to stop the reception of the first DC voltage Vm or first DC current IPHm through the interface 610 in the case in which the second DC voltage DC-IN is supplied through the DC voltage input terminal 632.

Accordingly, in the case in which the second DC voltage DC-IN is supplied through the DC voltage input terminal 632, the sink mode operation may be stopped.

Meanwhile, the power circuit device 630 may turn off the switching device 636 by stopping the reception of the first DC voltage Vm or first DC current IPHm.

Meanwhile, the power circuit device 630 may be configured to charge the internal battery BTA based on the second DC voltage DC-IN input through the DC voltage input terminal 632 or second DC current corresponding to the second DC voltage DC-IN.

Specifically, the power circuit device 630 may be configured to supply the second DC current corresponding to the second DC voltage DC-IN in the case in which the second DC voltage DC-IN is supplied through the DC voltage input terminal 632. Accordingly, the internal battery BTA may be stably charged in response to the supply of the DC voltage DC-IN input through the DC voltage input terminal 632.

FIG. 7C illustrates an example of the source mode operation of the interface of the image display apparatus according to the embodiment of the present disclosure.

Referring to FIG. 7C, the power controller 620 is configured to supply third DC voltage Vn or third DC current corresponding to the third DC voltage Vn through the interface 610 to the battery device 500 based on the source mode in the case in which the second DC voltage DC-IN or the second DC current is supplied through the DC voltage input terminal 632. Accordingly, a source mode operation for supplying the DC voltage to the external battery device 500 may be performed.

At this time, a level of the third DC current in the source mode may be smaller than the level of the first DC current in the sink mode.

Meanwhile, since the second DC voltage DC-IN or the second DC current is supplied through the DC voltage input terminal during the source mode operation, the power circuit device 630 may be configured to supply the second DC voltage DC-IN or the second DC current to the internal battery BTA. Accordingly, the internal battery BTA may be stably charged in response to the supply of the DC voltage DC-IN input through the DC voltage input terminal 632.

FIG. 7D illustrates another example of the source mode operation of the interface of the image display apparatus according to the embodiment of the present disclosure.

Referring to FIG. 7D, the power controller 620 may be configured to stop the supply of the third DC voltage Vn or the third DC current IPHn through the interface 610 in the case in which the supply of the second DC voltage DC-IN or the second DC current is stopped through the DC voltage input terminal 632 during the source mode operation. Accordingly, in the case in which the supply of the second DC voltage DC-IN is stopped through the DC voltage input terminal 632, the source mode operation may be stopped.

Meanwhile, since the supply of the second DC voltage DC-IN or the second DC current is stopped through the DC voltage input terminal during the source mode operation, the power circuit device 630 may stop of the charging mode of the internal battery BTA.

Meanwhile, in the case in which image displaying in the display 180 is required during stopping the source mode and stopping the charging mode, the power circuit device 630 switches the internal battery BTA to the discharging mode to operate the signal processing device 170 or the display 180 based on the DC voltage or DC current from the internal battery BTA. Accordingly, stable image displaying is enabled.

FIG. 7E illustrates an example of a display mode operation of the interface of the image display apparatus according to the embodiment of the present disclosure.

Referring to FIG. 7E, in the case in which the mobile terminal 600 is connected to the interface 610, the interface 610 may operate in a display mode based setting input or mode selection.

That is, the power controller 620 may be configured to receive display mode related information from the mobile terminal 600, and control the interface 610 to operate in the display mode based on the received display mode related information.

In response thereto, the interface 610 may be configured to receive an image signal Svd from the mobile terminal 600, and transmit the image signal Svd to the signal processing device 170 or the power controller 620, in the display mode.

Meanwhile, the signal processing device 170 performs signal processing for the image signal Svd to control an image corresponding to the signal-processed image signal Svd to be displayed in the display 180.

Meanwhile, the power controller 620 or the signal processing device 170 may be configured to continuously perform the display mode in the case in which the second DC voltage DC-IN or the second DC current is supplied through the DC voltage input terminal 632 during the display mode operation.

FIG. 7F illustrates another example of the display mode operation of the interface of the image display apparatus according to the embodiment of the present disclosure.

Referring to FIG. 7F, as in FIG. 7E, in the case in which the mobile terminal 600 is connected to the interface 610, the interface 610 may operate in the display mode based setting input or mode selection.

However, unlike FIG. 7E, there is a difference that the supply of the second DC voltage DC-IN or the second DC current is stopped through the DC voltage input terminal 632 during the display mode operation.

Meanwhile, the power controller 620 or the signal processing device 170 may be configured to continuously perform the display mode even though the supply of the second DC voltage DC-IN or the second DC current is stopped through the DC voltage input terminal 632 during the display mode operation.

That is, although the supply of the second DC voltage DC-IN or the second DC current is stopped, the interface 610 may be configured to receive the image signal Svd from the mobile terminal 600, and transmit the image signal Svd to the signal processing device 170 or the power controller 620 in the display mode, and the signal processing device 170 may performs signal processing for the image signal Svd, and display the image corresponding to the signal-processed image signal Svd in the display 180. Accordingly, stable image displaying is enabled.

FIG. 8 is an example of an internal block diagram of an image display device according to an embodiment of the present disclosure.

Referring to FIG. 8, an image display device 100 according to an embodiment of the present disclosure comprises a display 180, an interface 610 electrically connected to an external battery device 500 or a mobile terminal 600, a power controller 620 controlling a source mode or a sink mode of the interface 610, an internal battery BTA, and a charge/discharge circuit device 630 controlling a charge mode or a discharge mode of the internal battery BTA.

Meanwhile, the interface 610 according to an embodiment of the present disclosure may operate in any one of a sink mode, a source mode, and a display mode.

For example, in the case in which operating in the sink mode, the interface 610 may be configured to receive a first DC voltage Vm or a first DC current IPHm corresponding to the first DC voltage Vm from the external battery device 500 or the mobile terminal 600.

Meanwhile, in the case in which operating in the source mode, the interface 610 may be configured to supply a third DC voltage Vn or a third DC current IPHn corresponding to the third DC voltage Vn to the external battery device 500 or the mobile terminal 600.

Meanwhile, in the case in which operating in the display mode, the interface 610 may be configured to receive an image signal Svd from the mobile terminal 600.

Meanwhile, the interface 610 may include a USB-C type interface.

For example, the interface 610 may include a first port PT1 that receives the first DC voltage Vm in the sink mode or outputs the third DC voltage Vn to the outside in the source mode, and a second port PT2 that receives voltage information of the battery device 500 or the mobile terminal 600.

Meanwhile, the first port PT1 may be connected to a VBUS line, and the second port PT2 may be connected to a CC1/2 line.

Meanwhile, the interface 610 may further include a third port PT3 that is connected to a separate second bus SBU1/2 line in addition to the VBUS line as the first bus.

Meanwhile, the interface 610 may further include a fourth port PT4 and a fifth port PT5 for receiving an image signal Svd from the mobile terminal 600 or transmitting an image signal to the mobile terminal 600 in the case in which operating in the display mode.

Meanwhile, the fourth port PT4 may be connected to a TX1/RX1 line, and the fifth port PT5 may be connected to a TX2/RX2 line.

Meanwhile, the interface 610 may further include a fourth port PT4 and a fifth port PT5 for receiving an image signal Svd from the mobile terminal 600 or transmitting an image signal to the mobile terminal 600 in the case in which operating in the display mode.

Meanwhile, the fourth port PT4 may be connected to a TX1/RX1 line, and the fifth port PT5 may be connected to a TX2/RX2 line.

Meanwhile, the interface 610 may further include a sixth port PT6 for a USB 2.0 interface.

Meanwhile, the sixth port PT6 may be connected to a USB D+/D− line.

Meanwhile, the power circuit device 630 is provided with a DC voltage input terminal 632.

Meanwhile, the power circuit device 630 may further include a second interface 634 that supplies voltage or current to the internal battery BTA in a charging mode of the internal battery BTA and receives voltage or current in a discharging mode of the internal battery BTA, and a switching device 636 that performs switching to supply the voltage or current from the interface 610 to the second interface 634.

Meanwhile, the image display device 100 according to an embodiment of the present disclosure may further include a signal processing device 170 that outputs an image signal to the display 180.

Meanwhile, the image display device 100 according to an embodiment of the present disclosure may further include a dc/dc converter 644 that is electrically connected to the first port PT1.

Meanwhile, the dc/dc converter 644 may be connected between the first port PT1 of the interface 610 and a switch 647.

Meanwhile, the dc/dc converter 644 may lower the level of the first DC voltage Vm received through the first port PT1 in the sink mode and supply the lowered level DC voltage 5V_TYPE-C to the power controller 620 via the switch 647.

For example, the dc/dc converter 644 may lower the level of the first DC voltage Vm of about 5 to 20 V and supply the voltage of about 5 V to the power controller 620. Accordingly, the power controller 620 may be stably operated based on the DC voltage from the external battery device 500 or the mobile terminal 600.

Meanwhile, the switch 647 may also supply a level-converted DC voltage 5V_NORMAL based on the internal battery BTA to the power controller 620 in the case in which the first DC voltage Vm is not supplied through the interface 610.

Meanwhile, the DC voltage 5V_TYPE-C output from the dc/dc converter 644 may be input to the signal processing device 170.

At this time, the signal processing device 170 may be configured to receive a USB-C_CHG_DET signal related to the sink mode operation based on the DC voltage 5V_TYPE-C.

That is, the signal processing device 170 may determine the sink mode operation in the case in which the level of the USB-C_CHG_DET signal corresponding to the DC voltage 5V_TYPE-C is a high level.

Meanwhile, the power controller 620 is electrically connected to a plurality of ports PT2 to PT5 of the interface 610 and may be configured to receive signals from the plurality of ports PT2 to PT5 of the interface 610.

For example, the power controller 620 may be configured to receive voltage information or current information of the battery device 500 or the mobile terminal 600 through the second port PT2 of the interface 610.

As another example, the power controller 620 may be configured to receive an image signal Svd and transmit the image signal Svd to the signal processing device 170 or the power controller 620, through the fourth port PT4 or the fifth port PT5 of the interface 610 in the display mode.

Meanwhile, the power controller 620 may have a plurality of ports for signal transmission or reception with the signal processing device 170.

For example, the power controller 620 may include a VMON port for receiving a TYPE-C_VBUS signal, an MGPIO2 port for transmitting a TYPE-C_CC_DET signal, a GPIO4 port for transmitting an ALT_MODE_NOTICE signal, an I2C_EN/GPIO10 port for transmitting a 5V_USB-C_EN signal, an I2C_INT/GPIO9 port for transmitting a 65 W_USB-C_EN signal, an IMON port for transmitting a 100 W_USB-C_EN signal, a LOC_PWR_MON port for transmitting a TYPE-C_VBUS_DISCHARGE signal, etc.

Meanwhile, the TYPE-C_VBUS signal may correspond to a signal input to the first port PT1 of the interface 610 in the source mode.

Meanwhile, the power controller 620 may output a high-level 5V_USB-C_EN signal in the source mode, and a load switch 645 may be turned on based on the 5V_USB-C_EN signal.

Meanwhile, the power controller 620 may determine a first sink mode operation or a second sink mode operation in the sink mode, based on the voltage information or current information of the battery device 500 or the mobile terminal 600.

For example, the power controller 620 may output a high-level 65 W_USB-C_EN signal for the first sink mode operation based on 65 W 20V/3.25 A, or output a high-level 100 W_USB-C_EN signal for the second sink mode operation based on 100 W 20V/5 A, based on the voltage information or current information of the battery device 500 or the mobile terminal 600.

Meanwhile, the power controller 620 may output a high-level TYPE-C_VBUS_DISCHARGE signal for discharging TYPE-C_VBUS.

Meanwhile, a converter 642 for converting a display signal into an HDMI signal in the display mode may be further included between the power controller 620 and the signal processing device 170.

Meanwhile, the signal processing device 170 may output a reset signal RESET_N to reset the converter 642.

Meanwhile, the image display device 100 according to an embodiment of the present disclosure may further include a load switch 645 electrically connected to the first port PT1 of the interface 610.

Meanwhile, the image display device 100 according to an embodiment of the present disclosure may further include a barrier diode connected between the load switch 645 and the first port PT1 of the interface 610.

Meanwhile, the load switch 645 is turned off in the sink mode. Accordingly, the barrier diode and the first port PT1 of the interface 610 are electrically insulated from each other.

Meanwhile, the load switch 645 is turned on in the source mode and may be configured to supply the third DC voltage Vn to the first port PT1 based on the conduction of the barrier diode. Accordingly, in the source mode, the DC voltage may be stably supplied to the external battery device 500 or the mobile terminal 600.

Meanwhile, the interface 610 may be configured to supply the first DC voltage Vm received through the first port PT1 in the sink mode to the power circuit device 630. Accordingly, the internal battery BTA may be easily charged through the sink mode.

Meanwhile, the power circuit device 630 may further include a DC voltage input terminal 632, a second interface 634 that supplies voltage or current to the internal battery BTA in a charging mode of the internal battery BTA and receives voltage or current in a discharging mode of the internal battery BTA, and a switching device 636 that performs switching to supply the voltage or current from the interface 610 to the second interface 634.

Meanwhile, the power circuit device 630 may be configured to supply a voltage of approximately 13 V to the interface 652 of the main circuit board MD in the case in which the second DC voltage DC-IN is supplied through the DC voltage input terminal 632.

Meanwhile, the power circuit device 630 may be configured to transmit a high-level power signal POWER_ACD to the switching element 653 in the main circuit board MD in the case in which the second DC voltage DC-IN is supplied through the DC voltage input terminal 632.

Meanwhile, the main circuit board MD may further include a signal receiving device 656 including a first diode to which a 65 W_USB-C_EN signal is applied and a second diode to which a 100 W_USB-C_EN signal is applied, a second switching element 658 connected to the signal receiving device 656, and a switching element 653 having one end connected between the signal receiving device 656 and the second switching element 658.

For example, in the case in which the second DC voltage DC-IN is supplied through the DC voltage input terminal 632, a high-level power signal POWER_ACD is input to the switching element 653, and the switching element 653 is turned off. Accordingly, the second switching element 658 is also turned off.

Accordingly, a 20V_VBUS_ON/OFF signal output from the second switching element 658 becomes a low level, and the switching element 636 in the power circuit device 630 is turned off based on the low-level 20V_VBUS_ON/OFF signal.

Accordingly, in the case in which the second DC voltage DC-IN is supplied through the DC voltage input terminal 632, the supply of the first DC voltage Vm or the first DC current IPHm to the power circuit device 630 is stopped due to the turn-off of the switching element 636.

As another example, in the case in which the second DC voltage DC-IN is supplied through the DC voltage input terminal 632, a low-level power signal POWER_ACD is input to the switching element 653, and the switching element 653 is turned on.

Meanwhile, depending on the operation of the sink mode, if either the 65 W_USB-C_EN signal or the 100 W_USB-C_EN signal is at a high level, the signal receiving device 656 is conducted and the second switching element 658 is also turned on.

Accordingly, the 20V_VBUS_ON/OFF signal output from the second switching element 658 becomes a high level, and the switching element 636 in the power circuit device 630 is turned on based on the high-level 20V_VBUS_ON/OFF signal.

Accordingly, in the case in which the second DC voltage DC-IN is not supplied through the DC voltage input terminal 632, the first DC voltage Vm or the first DC current IPHm is supplied to the power circuit device 630 due to the turn-on of the switching device 636. Accordingly, it is possible to stably charge the internal battery BTA.

FIGS. 9A to 10C are diagrams referred to for description of the operation of FIG. 8.

FIG. 9A (a) is a diagram illustrating a level of each signal in the case in which the second DC voltage DC-IN is supplied and in the case in which the supply is stopped.

Referring to FIG. 9A (a), in the case in which the second DC voltage DC-IN is supplied, the level of the power signal POWER_ACD becomes a high level, the 20V_VBUS_ON/OFF signal becomes a low level, and the switching device 636 in the charge/discharge circuit device 630 is turned off. Accordingly, the sink mode is stopped and the source mode may be performed.

Meanwhile, in the case in which the second DC voltage DC-IN is not supplied, the level of the power signal POWER_ACD becomes a low level, the 20V_VBUS_ON/OFF signal becomes a high level, and the switching device 636 in the charge/discharge circuit device 630 is turned on. Accordingly, the sink mode may be performed.

FIG. 9A (b) is a diagram illustrating the first sink mode and the second sink mode in the sink mode.

Referring to FIG. 9A (b), the power controller 620 may operate in the sink mode, based on voltage information or current information of the battery device 500 or the mobile terminal 600.

In the sink mode, a USB-C_CHG_DET signal corresponding to the DC voltage 5V_TYPE-C output from the dc/dc converter 644 electrically connected to the first port PT1 may be a high level.

Meanwhile, the power controller 620 may be configured to receive a first level of current or a second level of current greater than the first level from the battery device 500 or the mobile terminal 600 through the interface 610 in the sink mode, based on the voltage information or current information of the battery device 500 or the mobile terminal 600 received through the interface 610.

Meanwhile, the power controller 620 may determine operation in a first sink mode or a second sink mode in the sink mode, based on the voltage information or current information of the battery device 500 or the mobile terminal 600. Accordingly, it is possible to receive various levels of current in the sink mode.

For example, the power controller 620 may be configured to operate in the first sink mode in the case in which the voltage information or current information of the battery device 500 or the mobile terminal 600 is equal to or greater than a reference level and less than a first set level, and may be configured to operate in the second sink mode in the case in which the voltage information or current information is equal to or greater than the reference level and equal to or greater than the first set level.

That is, in the first sink mode, the power controller 620 may output a high-level 65 W_USB-C_EN signal through I2C_INT/GPIO9, and the level of the low-level 100 W_USB-C_EN signal may be a low level through the IMON//GPIO8 port.

Accordingly, in the case of the first sink mode, the first port PT1 of the interface 610 may be configured to receive a first level of current from the battery device 500, and the power circuit device 630 may be configured to receive a first level of current from the interface 610 and supply the first level of current to the internal battery BTA. At this time, the first level may be 0.1 C-rate.

Meanwhile, in the second sink mode, the power controller 620 may output a low-level 65 W_USB-C_EN signal through I2C_INT/GPIO9, and the level of the high-level 100 W_USB-C_EN signal may be a low level through the IMON//GPIO8 port.

Accordingly, in the case of the first sink mode, the first port PT1 of the interface 610 may be configured to receive a second level of current greater than the first level from the battery device 500, and the power circuit device 630 may be configured to receive a second level of current from the interface 610 and supply the second level of current to the internal battery BTA. At this time, the second level may be 0.4 C-rate.

FIG. 9B is a diagram referring to the operation description of the power controller and the signal processing device.

Referring to FIG. 9B, in the first sink mode, in the case in which the second DC voltage DC-IN is not supplied, the USB-C_CHG_DET signal may be at a high level, the level of the 100 W_USB-C_EN signal output through the IMON//GPIO8 port may be a low level, the level of the 65 W_USB-C_EN signal output through I2C_INT/GPIO9 may be a high level, and the level of the power signal POWER_ACD may be a low level. At this time, the signal processing device 170 does not output a mode change message PR_Swap.

Meanwhile, in the second sink mode, in the case in which the second DC voltage DC-IN is not supplied, the USB-C_CHG_DET signal may be at a high level, the level of the 100 W_USB-C_EN signal output through the IMON//GPIO8 port may be a high level, the level of the 65 W_USB-C_EN signal output through I2C_INT/GPIO9 may be a low level, and the level of the power signal POWER_ACD may be a low level. At this time, the signal processing device 170 does not output a mode change message PR_Swap.

Meanwhile, the signal processing device 170 may output the mode change message PR_Swap in the case in which the second DC voltage DC-IN is supplied through the DC voltage input terminal 632 during the first sink mode or the second sync operation.

For example, in the first sink mode, in the case in which the second DC voltage DC-IN is supplied, the USB-C_CHG_DET signal may be at a high level, the level of the 100 W_USB-C_EN signal output through the IMON//GPIO8 port may be a low level, the level of the 65 W_USB-C_EN signal output through I2C_INT/GPIO9 may be a high level, and the level of the power signal POWER_ACD may be a high level. At this time, the signal processing device 170 outputs a mode change message PR_Swap.

As another example, in the second sink mode, in the case in which the second DC voltage DC-IN is not supplied, the USB-C_CHG_DET signal may be at a high level, the level of the 100 W_USB-C_EN signal output through the IMON//GPIO8 port may be a high level, the level of the 65 W_USB-C_EN signal output through I2C_INT/GPIO9 may be a low level, and the level of the power signal POWER_ACD may be a high level. At this time, the signal processing device 170 outputs a mode change message PR_Swap.

Meanwhile, the power controller 620 may be configured to switch the first sink mode or the second sink mode to the source mode based on the mode change message PR_Swap.

Meanwhile, the power controller 620 may be configured to turn on the load switch 645 based on the mode change message PR_Swap, and control to supply the third DC voltage Vn or the third DC current IPHn corresponding to the third DC voltage Vn to the interface 610 through the load switch 645. Accordingly, it is possible to perform a source mode operation for supplying the DC voltage to the external battery device 500 or the mobile terminal 600.

Meanwhile, the power controller 620 may be configured to supply current of a third level IPHn smaller than the first level IPHm to the battery device 500 or the mobile terminal 600 through the interface 610, in the source mode.

For example, the first level of the first DC current IPHm in the first sink mode may be approximately 3.25 A, the second level of the first DC current IPHm in the second sink mode may be approximately 5 A, and the third level of the third DC current IPHn in the source mode may be approximately 3 A.

Accordingly, it is possible to stably perform a source mode operation for supplying the DC voltage to the external battery device 500 or the mobile terminal 600.

FIG. 10A is a diagram referring to the operation description in the case in which the second DC voltage is not supplied through the DC voltage input terminal during the operation of the sink mode.

Referring to FIG. 10A, the power controller 620 is configured to receive a first DC voltage Vm or a first DC current IPHm corresponding to the first DC voltage Vm from the battery device 500 or the mobile terminal 600 through the interface 610, in the case in which the second DC voltage DC-IN is not supplied through the DC voltage input terminal 632 in the sink mode.

Meanwhile, the power controller 620 may be configured to receive a first level of current or a second level of current greater than the first level from the battery device 500 or the mobile terminal 600 through the interface 610 in the sink mode, based on the voltage information or current information of the battery device 500 or the mobile terminal 600 received through the interface 610. Accordingly, it is possible to receive various levels of current in the sink mode.

Meanwhile, the power circuit device 630 may be configured to supply the first level of current or the second level of current from the interface 610 to the internal battery BTA in the sink mode. Accordingly, the internal battery BTA may be charged based on various levels of current in the sink mode.

FIG. 10B is a diagram referring to the operation description in the case in which the second DC voltage is supplied through the DC voltage input terminal during the operation of the sink mode.

Referring to FIG. 10B, the power controller 620 may be configured to stop the reception of the first DC voltage Vm through the interface 610, in the case in which the second DC voltage DC-IN is supplied through the DC voltage input terminal 632 in the sink mode. Accordingly, in the case in which the second DC voltage DC-IN is supplied through the DC voltage input terminal 632, the sink mode operation may be stopped.

Meanwhile, the power circuit device 630 may be configured to supply current corresponding to the second DC voltage DC-IN to the internal battery BTA, in the case in which the second DC voltage DC-IN is supplied through the DC voltage input terminal 632 in the sink mode. Accordingly, the internal battery BTA may be easily charged through the sink mode.

FIG. 10C is a diagram referring to the operation description of the source mode.

Referring to FIG. 10C, the power controller 620 may control the supply of the third DC voltage Vn to the battery device 500 or the mobile terminal 600 through the interface 610 based on the source mode, in the case in which the second DC voltage DC-IN is supplied through the DC voltage input terminal 632 in the source mode. Accordingly, it is possible to perform a source mode operation for supplying the DC voltage to the external battery device 500 or the mobile terminal 600.

Meanwhile, the power controller 620 may be configured to stop the supply of the third DC voltage Vn or the third DC current IPHn corresponding to the third DC voltage Vn through the interface 610, in the case in which the supply of the second DC voltage DC-IN is stopped through the DC voltage input terminal 632 during the operation in the source mode. Accordingly, in the case in which the supply of the second DC voltage DC-IN is stopped through the DC voltage input terminal 632, the source mode operation may be stopped.

Meanwhile, the interface 610 may be configured to transmit the image signal received from the mobile terminal 600 to the signal processing device 170 or the power controller 620 based on the display mode. Accordingly, the image signal received from the mobile terminal 600 may be easily displayed on the display 180 through the display mode.

Meanwhile, the interface 610 may be configured to continuously transmit the image signal received from the mobile terminal 600 to the signal processing device 170 or the power controller 620, in the case in which the second DC voltage DC-IN is supplied through the DC voltage input terminal 632 during operation in the display mode.

Accordingly, even if the second DC voltage DC-IN is supplied through the DC voltage input terminal 632, the image signal received from the mobile terminal 600 may be stably displayed on the display 180 through the display mode.

Meanwhile, an image display device 100 according to another embodiment of the present disclosure comprises a display 180, an interface 610 electrically connected to an external battery device 500 or a mobile terminal 600, a power controller 620 controlling a source mode or sink mode of the interface 610, and a DC voltage input terminal 632.

Meanwhile, the power controller 620 according to another embodiment of the present disclosure is configured to receive a first DC voltage Vm from the battery device 500 or the mobile terminal 600 through the interface 610 in the sink mode, stop the reception of the first DC voltage Vm through the interface 610 in the case in which the second DC voltage DC-IN is supplied through the DC voltage input terminal 632 during a sink mode operation, and switch to the source mode to supply the third DC voltage Vn to the battery device 500 or the mobile terminal 600 through the interface 610. Accordingly, it is possible to perform a source mode operation for supplying the DC voltage to the external battery device 500 or the mobile terminal 600.

FIG. 11 illustrates an example of an internal block diagram of an image display apparatus according to another embodiment of the present disclosure.

Referring to FIG. 11, an image display apparatus 100b according to another embodiment of the present disclosure includes a display 180, an interface 610 electrically connected to an external device 1200, a power controller 620 configured to determine an operation mode of a source mode, a sink mode, or a display mode whenever the external device 1200 is connected to the interface 610, a signal processing device 170b configured to output an image signal to the display 180, a resistor Ro between the power controller 620 and the signal processing device 170b, and a DC voltage input terminal 632.

Meanwhile, when DC voltage DC-IN is supplied through the DC voltage input terminal 632, the power controller 620 is configured to output a high-level signal to the resistor Ro, and control to operate in the source mode. Accordingly, a source mode operation for supplying the DC voltage to the external device 1200 can be performed.

Meanwhile, when the supply of the DC voltage DC-IN is stopped through the DC voltage input terminal 632 while operating in the source mode, the power controller 620 may be configured to control the interface 610 to operate in the sink mode. Accordingly, the sink mode operation for receiving the DC voltage from the external device 1200 can be performed.

At this time, the external device 1200 may be a battery device 500, a mobile terminal 600, or a tablet or a laptop.

Meanwhile, the interface 610 according to an embodiment of the present disclosure may be configured to operate in any one of the sink mode, the source mode, and the display mode.

For example, the interface 610 may be configured to receive information from the external device 1200 whenever the external device 1200 is connected.

Meanwhile, the power controller 620 may be configured to determine whether the interface 610 of the image display apparatus 100b operates in the source mode, operates in the sink mode, or operates in the display mode based on the information received from the external device 1200 whenever the external device 1200 is connected.

For example, the power controller 620 may be configured to determine whether the interface 610 of the image display apparatus 100b operates in the source mode, operates in the sink mode, or operates in the display mode based on a power delivery negotiation with the external device 1200.

For example, when operating in the sink mode, the interface 610 may be configured to receive a first DC voltage Vm for a first DC current IPHm corresponding to the first DC voltage Vm from the external device 1200.

Meanwhile, the power circuit device 630 may be configured to receive a second DC voltage DC-IN through the DC voltage input terminal 632.

Meanwhile, when operating in the source mode, the interface 610 may be configured to supply a third DC voltage Vn or a third DC current IPHn corresponding to the third DC voltage Vn to the external device 1200.

Meanwhile, when operating in the display mode, the interface 610 may be configured to receive an image signal Svd from the external device 1200.

Meanwhile, the interface 610 may include a USB-C type interface.

For example, the interface 610 may include a first port PT1 to a sixth port PT6.

The description of the first port PT1 to the sixth port PT6 is omitted with reference to FIG. 8.

Meanwhile, the power circuit device 630 is provided with the DC voltage input terminal 632.

Meanwhile, the power circuit device 630 may further include a second interface 634 configured to supply voltage or current to the internal battery BTA in a charging mode of the internal battery BTA and receives voltage or current in a discharging mode of the internal battery BTA, and a switching device 636 configured to perform switching to supply the voltage or current from the interface 610 to the second interface 634.

Meanwhile, the image display apparatus 100b according to another embodiment of the present disclosure may further include a dc/dc converter 644 electrically connected to the first port PT1.

Meanwhile, an operation of the dc/dc converter 644 is omitted with reference to FIG. 8.

Meanwhile, a DC voltage 5V_TYPE-C output from the dc/dc converter 644 may be input to the signal processing device 170b.

At this time, the signal processing device 170 may be configured to receive a USB-C_CHG_DET signal related to the sink mode operation based on the DC voltage 5V_TYPE-C.

That is, the signal processing device 170 may be configured to determine that the image display apparatus 100b operates in the sink mode when the level of the USB-C_CHG_DET signal corresponding to the DC voltage 5V_TYPE-C is a high level.

Meanwhile, the power controller 620 may be electrically connected to a plurality of ports PT2 to PT5 of the interface 610 and may receive signals from the plurality of ports PT2 to PT5 of the interface 610.

For example, the power controller 620 may be configured to receive voltage information or current information of the external device 1200 through the second port PT2 of the interface 610.

As another example, the power controller 620 may be configured to receive an image signal Svd and transmit the image signal Svd to the signal processing device 170b or the power controller 620, through the fourth port PT4 or the fifth port PT5 of the interface 610 in the display mode.

Meanwhile, the power controller 620 may have a plurality of ports for signal transmission or reception with the signal processing device 170b.

For example, the power controller 620 may include a VMON port for receiving a TYPE-C_VBUS signal, an MGPIO2 port for transmitting a TYPE-C_CC_DET signal, a GPIO4 port for transmitting an ALT_MODE_NOTICE signal, an I2C_EN/GPIO10 port for transmitting a 5V_USB-C_EN signal, an I2C_INT/GPIO9 port for transmitting a 65 W_USB-C_EN signal, an IMON/MGPIO8 port for transmitting a 100 W_USB-C_EN signal, a LOC_PWR_MON port for transmitting a TYPE-C_VBUS_DISCHARGE signal, etc.

Meanwhile, the resistor Ro may be disposed between the I2C_EN/GPIO10 port of the power controller 620, and the signal processing device 170b.

For example the 5V_USB-C_EN signal output from the I2C_EN/GPIO10 port of the power controller 620 may be output to each of the load switch 645 and the resistor Ro.

Meanwhile, the 5V_USB-C_EN signal input to the resistor Ro may be converted into the 5V_SOURCE_ON signal and input to the signal processing device 170b.

For example, when the 5V_USB-C_EN signal output from the I2C_EN/GPIO10 port of the signal processing device 170b is at the high level, the load switch 645 may be turned on, and the high-level 5V_SOURCE_ON signal may be input to the signal processing device 170b.

Meanwhile, the signal processing device 170b may be configured to control the image display apparatus 100b to operate in the source mode based on the high-level 5V_SOURCE_ON signal.

Meanwhile, the TYPE-C_VBUS signal may correspond to a signal input to the first port PT1 of the interface 610 in the source mode.

Meanwhile, the power controller 620 may be configured to output the high-level 5V_USB-C_EN signal in the source mode, and the load switch 645 may be turned on based on the 5V_USB-C_EN signal.

Meanwhile, the power controller 620 may be configured to determine a first sink mode operation or a second sink mode operation in the sink mode, based on the voltage information or current information of the external device 1200.

For example, the power controller 620 may be configured to output a high-level 65 W_USB-C_EN signal for the first sink mode operation based on 65 W 20V/3.25 A, or output a high-level 100 W_USB-C_EN signal for the second sink mode operation based on 100 W 20V/5 A, based on the voltage information or current information of the external device 1200.

Meanwhile, the power controller 620 may be configured to output a high-level TYPE-C_VBUS_DISCHARGE signal for discharging TYPE-C_VBUS.

Meanwhile, a converter 642 for converting a display signal into an HDMI signal in the display mode may be further included between the power controller 620 and the signal processing device 170b.

Meanwhile, the signal processing device 170b is configured to output a reset signal RESET_N to reset the converter 642.

Meanwhile, the image display apparatus 100b according to another embodiment of the present disclosure may further include the load switch 645 (barrier diode) as illustrated in FIG. 8.

Meanwhile, the load switch 645 is turned off in the sink mode. As a result, the barrier diode and the first port PT1 of the interface 610 are electrically insulated from each other.

Meanwhile, the load switch 645 is turned on in the source mode and may supply the third DC voltage Vn to the first port PT1 based on the conduction of the barrier diode. Accordingly, in the source mode, the DC voltage may be stably supplied to the external device 1200.

Meanwhile, the interface 610 may be configured to supply the first DC voltage Vm received through the first port PT1 in the sink mode to the power circuit device 630. Accordingly, the internal battery BTA may be easily charged through the sink mode.

Meanwhile, the power circuit device 630 may further include a DC voltage input terminal 632, a second interface 634 that supplies voltage or current to the internal battery BTA in a charging mode of the internal battery BTA and receives voltage or current in a discharging mode of the internal battery BTA, and a switching device 636 that performs switching to supply the voltage or current from the interface 610 to the second interface 634.

Meanwhile, the power circuit device 630 may be configured to supply a voltage of approximately 13 V to the interface 652 of the main circuit board MD when the second DC voltage DC-IN is supplied through the DC voltage input terminal 632.

Meanwhile, the power circuit device 630 may be configured to transmit a high-level power signal POWER_ACD to the switching element 653 in the main circuit board MD when the second DC voltage DC-IN is supplied through the DC voltage input terminal 632.

Meanwhile, as illustrated in FIG. 8, the main circuit board MD may further include a signal receiving device 656, a second switching element 658 connected to the signal receiving device 656, and a switching element 653 having one end connected between the signal receiving device 656 and the second switching element 658.

For example, when the second DC voltage DC-IN is supplied through the DC voltage input terminal 632, a high-level power signal POWER_ACD is input to the switching element 653, and the switching element 653 is turned off. As a result, the second switching element 658 is also turned off.

As a result, a 20V_VBUS_ON/OFF signal output from the second switching element 658 becomes a low level, and the switching element 636 in the power circuit device 630 is turned off based on the low-level 20V_VBUS_ON/OFF signal.

Accordingly, when the second DC voltage DC-IN is supplied through the DC voltage input terminal 632, the supply of the first DC voltage Vm or the first DC current IPHm to the power circuit device 630 is stopped due to the turn-off of the switching element 636.

As another example, when the second DC voltage DC-IN is supplied through the DC voltage input terminal 632, a low-level power signal POWER_ACD is input to the switching element 653, and the switching element 653 is turned on.

Meanwhile, depending on the operation of the sink mode, if either the 65 W_USB-C_EN signal or the 100 W_USB-C_EN signal is at the high level, the signal receiving device 656 is conducted and the second switching element 658 is also turned on.

As a result, the 20V_VBUS_ON/OFF signal output from the second switching element 658 becomes a high level, and the switching element 636 in the power circuit device 630 is turned on based on the high-level 20V_VBUS_ON/OFF signal.

Consequently, when the second DC voltage DC-IN is not supplied through the DC voltage input terminal 632, the first DC voltage Vm or the first DC current IPHm is supplied to the power circuit device 630 due to the turn-on of the switching device 636. As a result, it is possible to stably charge the internal battery BTA.

The power controller 620 in the image display apparatus 100b according to another embodiment of the present disclosure may determine the operation mode based on the information from the external device 1200 when being connected to the external device 1200.

For example, when the external device 1200 operates in the sink mode, the power controller 620 in the image display apparatus 100b may be configured to control the interface 610 to operate in the source mode of supplying the DC voltage to the external device 1200.

As another example, when the external device 1200 operates in the source mode, the power controller 620 in the image display apparatus 100b may be configured to control the interface 610 to operate in the sink mode of receiving the DC voltage from the external device 1200.

As yet another example, when the external device 1200 operates in the display mode, the power controller 620 in the image display apparatus 100b may be configured to control the interface 610 to operate in the display mode of receiving the image signal from the external device 1200.

Meanwhile, the power controller 620 in the image display apparatus 100b according to another embodiment of the present disclosure may be configured to control the third DC voltage Vn or the third DC current IPHn corresponding to the third DC voltage Vn to be supplied to the external device 1200 through the interface 610 when the second DC voltage DC-IN is supplied through the DC voltage input terminal 632 while the interface 610 operates in the sink mode.

Meanwhile, the power controller 620 in the image display apparatus 100b according to another embodiment of the present disclosure may be configured to control the supply of the third DC voltage Vn or the third DC current IPHn corresponding to the third DC voltage Vn to be stopped through the interface 610 when the supply of the second DC voltage DC-IN is stopped through the DC voltage input terminal 632 while the interface 610 operates in the source mode.

FIG. 12 illustrates an example of a flowchart illustrating an operation method of the image display apparatus of FIG. 11.

Referring to FIG. 12, the power controller 620 in the image display apparatus 100b according to another embodiment of the present disclosure is configured to determine whether the external device 1200 is connected to the interface 610 (S1110).

For example, the power controller 620 in the image display apparatus 100b may be configured to receive information from the external device 1200 through the interface 610.

For example, the information may include voltage information or current information of the external device 1200.

Meanwhile, the interface 610 according to an embodiment of the present disclosure may operate in any one of the sink mode, the source mode, and the display mode.

For example, the interface 610 may be configured to receive the information from the external device 1200 whenever the external device 1200 is connected.

Meanwhile, the power controller 620 may be configured to determine whether the interface 610 of the image display apparatus 100b operates in the source mode, operates in the sink mode, or operates in the display mode based on the information received from the external device 1200 whenever the external device 1200 is connected (S1115).

For example, the power controller 620 may be configured to determine whether the interface 610 of the image display apparatus 100b operates in the source mode, operates in the sink mode, or operates in the display mode based on the power delivery negotiation based on the information received from the external device 1200.

Meanwhile, the power controller 620 in the image display apparatus 100b may be configured to determine whether the image display apparatus 100b operates in the display mode (S1120), and when the image display apparatus 100b operates in the display mode, the power controller 620 in the image display apparatus 100b may be configured to receive the image signal Svd from the external device 1200 and transmit the image signal Svd to the signal processing device 170b.

Meanwhile, in step 1120 (S1120), when the interface 610 is not in the display mode, the power controller 620 in the image display apparatus 100b or the signal processing device 170b may be configured to determine whether the interface 610 is in the source mode (S1125), and when the interface 610 is in the source mode, the power controller 620 in the image display apparatus 100b or the signal processing device 170b may be configured to determine whether the DC voltage DC-IN is supplied through the DC voltage input terminal 632 (S1130).

For example, when DC voltage DC-IN is supplied through the DC voltage input terminal 632 while the interface 610 is in the source mode, the power circuit device 630 may be configured to output a high-level power signal POWER_ACD, and operate in the source mode in the source mode as it is.

Meanwhile, in step 1130 (S1130), when the DC voltage DC-IN is not supplied or the supply of the DC voltage DC-IN is stopped, through the DC voltage input terminal 632, the signal processing device 170b may be configured to output a mode change message PR_Swap in order to prevent voltage-down of the internal battery BTA, etc. (S1135)

Meanwhile, the interface 610 may be switched from the source mode to the sink mode based on the mode change message PR_Swap (S1138).

Meanwhile, when the interface 610 is not in the source mode in step 1125 (S1125), the interface 610 of the image display apparatus 100b may be configured to operate in the sink mode.

Meanwhile, while the interface 610 of the image display apparatus 100b operates in the sink mode, the power controller 620 in the image display apparatus 100b or the signal processing device 170b may be configured to determine whether the DC voltage DC-IN is supplied through the DC voltage input terminal 632 (S1140).

Meanwhile, when the DC voltage DC-IN is supplied through the DC voltage input terminal 632 while the interface 610 of the image display apparatus 100b is configured to operate in the sink mode, the signal processing device 170b may output the mode change message PR_Swap (S1145).

Meanwhile, the interface 610 may be switched from the sink mode to the source mode based on the mode change message PR_Swap (S1148).

FIGS. 13A to 13D are diagrams referred to for description of the operation of FIG. 11 or 12.

First, FIG. 13A illustrates a sink mode operation of the image display apparatus 100b of FIG. 11 or 12.

Referring to FIG. 13A, when the power information of the external device 1200 is less than a first reference value, the image display apparatus 100b may be configured to determine stop the sink mode operation as illustrated in (c) of FIG. 13A.

Meanwhile, when the power information of the external device 1200 is equal to more than the first reference value and less than a second reference value, the image display apparatus 100b may be configured to operate in the first sink mode and supply first-level current to the internal battery BTA as illustrated in (b) of FIG. 13A. At this time, the first level may be 0.1 C-rate.

Meanwhile, when the power information of the external device 1200 is equal to more than the second reference value and less than a third reference value, the image display apparatus 100b may be configured to operate in the second sink mode and supply second-level current to the internal battery BTA as illustrated in (a) of FIG. 13A. At this time, the second level may be 0.4 C-rate.

Meanwhile, the first reference value, the second reference value, and the third reference value may be 65 W, 85 W, and 100 W, respectively, but are not limited thereto, and are enabled to be variously modified.

Next, FIG. 13B illustrates that the supply of the DC voltage DC-IN is stopped through the DC voltage input terminal 632 while the image display apparatus 100b of FIG. 11 or 12 operates in various modes.

As illustrated in (a) of FIG. 13B, when the supply of the DC voltage DC-IN is stopped while the image display apparatus 100b is in the second sink mode, the IMON//GPIO8 port may output the high-level signal, the I2C_INT/GPIO9 port may output the low-level signal, and the GPIO4 port may output the high-level ALT_MODE_NOTICE signal, the low-level 5V_SOURCE_ON signal, and the low-level POWER_ACD signal. As a result, the image display apparatus 100b continuously operates in the second sink mode.

As illustrated in (b) of FIG. 13B, when the supply of the DC voltage DC-IN is stopped while the image display apparatus 100b is in the first sink mode, the IMON//GPIO8 port may output the low-level signal, the I2C_INT/GPIO9 port may output the high-level signal, and the GPIO4 port may output the high-level ALT_MODE_NOTICE signal, the low-level 5V_SOURCE_ON signal, and the low-level POWER_ACD signal. As a result, the image display apparatus 100b continuously operates in the first sink mode.

As illustrated in (c) of FIG. 13B, when the supply of the DC voltage DC-IN is stopped while the image display apparatus 100b is in the display mode, the IMON//GPIO8 port may output the low-level signal, the I2C_INT/GPIO9 port may output the low-level signal, and the GPIO4 port may output the low-level ALT_MODE_NOTICE signal, the high-level 5V_SOURCE_ON signal, and the low-level POWER_ACD signal. As a result, the image display apparatus 100b continuously operates in the display mode.

As illustrated in (d) of FIG. 13B, when the supply of the DC voltage DC-IN is stopped while the image display apparatus 100b is in the source mode, the IMON//GPIO8 port may output the low-level signal, the I2C_INT/GPIO9 port may output the low-level signal, and the GPIO4 port may output the high-level ALT_MODE_NOTICE signal, the high-level 5V_SOURCE_ON signal, and the low-level POWER_ACD signal.

At this time, the signal processing device 170b may output the mode change message PR_Swap. As a result, the image display apparatus 100b may be switched from the source mode to the first sink mode or the second sink mode to the source mode based on the mode change message PR_Swap.

Next, FIG. 13C illustrates that the DC voltage DC-IN is supplied through the DC voltage input terminal 632 while the image display apparatus 100b of FIG. 11 or 12 operates in various modes.

As illustrated in (a) of FIG. 13C, when the DC voltage DC-IN is supplied while the image display apparatus 100b is in the second sink mode, the IMON//GPIO8 port may output the high-level signal, the I2C_INT/GPIO9 port may output the low-level signal, and the GPIO4 port may output the high-level ALT_MODE_NOTICE signal, the low-level 5V_SOURCE_ON signal, and the high-level POWER_ACD signal.

At this time, the signal processing device 170b may output the mode change message PR_Swap. As a result, the image display apparatus 100b may be switched from the second sink mode to the source mode based on the mode change message PR_Swap.

As illustrated in (b) of FIG. 13C, when the DC voltage DC-IN is supplied while the image display apparatus 100b is in the first sink mode, the IMON//GPIO8 port may output the low-level signal, the I2C_INT/GPIO9 port may output the high-level signal, and the GPIO4 port may output the high-level ALT_MODE_NOTICE signal, the low-level 5V_SOURCE_ON signal, and the high-level POWER_ACD signal.

At this time, the signal processing device 170b may output the mode change message PR_Swap. As a result, the image display apparatus 100b may be switched from the first sink mode to the source mode based on the mode change message PR_Swap.

As illustrated in (c) of FIG. 13C, when the DC voltage DC-IN is supplied while the image display apparatus 100b is in the display mode, the IMON//GPIO8 port may output the low-level signal, the I2C_INT/GPIO9 port may output the low-level signal, and the GPIO4 port may output the low-level ALT_MODE_NOTICE signal, the high-level 5V_SOURCE_ON signal, and the high-level POWER_ACD signal. As a result, the image display apparatus 100b continuously operates in the display mode.

As illustrated in (d) of FIG. 13C, when the DC voltage DC-IN is supplied while the image display apparatus 100b is in the source mode, the IMON//GPIO8 port may output the low-level signal, the I2C_INT/GPIO9 port may output the low-level signal, and the GPIO4 port may output the high-level ALT_MODE_NOTICE signal, the high-level 5V_SOURCE_ON signal, and the high-level POWER_ACD signal. As a result, the image display apparatus 100b continuously operates in the source mode.

FIG. 13D illustrates a description of the operation upon the mode change by the mode change message PR_Swap of the signal processing device 170b.

Referring to FIG. 13D, as illustrated in (a) of FIG. 13D, when the supply of the DC voltage DC-IN is stopped, the image display apparatus 100b may operate is in the second sink mode, and output the low-level POWER_ACD signal, the IMON//GPIO8 port may output the high-level signal, and the I2C_INT/GPIO9 port may output the low-level signal and the low-level 5V_SOURCE_ON signal.

As illustrated in (b) of FIG. 13D, when the supply of the DC voltage DC-IN is stopped, the image display apparatus 100b may operate is in the first sink mode, and output the low-level POWER_ACD signal, the IMON//GPIO8 port may output the low-level signal, and the I2C_INT/GPIO9 port may output the high-level signal and the low-level 5V_SOURCE_ON signal.

As illustrated in (c) of FIG. 13D, when the DC voltage DC-IN is supplied, the image display apparatus 100b may operate is in the source mode, and output the high-level POWER_ACD signal, the IMON//GPIO8 port may output the low-level signal, and the I2C_INT/GPIO9 port may output the low-level signal and the high-level 5V_SOURCE_ON signal.

As described above, an image display apparatus according to an embodiment of the present disclosure includes: a display; an interface electrically connected to an external battery device or a mobile terminal; a power controller configured to control a source mode or a sink mode of the interface; an internal battery; and a power circuit device including a DC voltage input terminal, and configured to control a charging mode or a discharging mode of the internal battery, and the power controller is configured to receive first DC voltage from the battery device or the mobile terminal through the interface in the case in which DC voltage is not supplied through the DC voltage input terminal in the sink mode, and supply third DC voltage to the battery device or the mobile terminal through the interface based on the source mode in the case in which second DC voltage is supplied through the DC voltage input terminal. Accordingly, it is possible to perform a source mode operation for supplying the DC voltage to the external battery device or the mobile terminal.

Meanwhile, the power controller may be configured to stop reception of the first DC voltage through the interface in the case in which the second DC voltage is supplied through the DC voltage input terminal in the sink mode. Accordingly, in the case in which the second DC voltage is supplied through the DC voltage input terminal, the sink mode operation may be stopped.

Meanwhile, the power controller may be configured to stop the supply of the third DC voltage through the interface in the case in which the supply of the second DC voltage is stopped through the DC voltage input terminal during operating in the source mode. Accordingly, in the case in which the supply of the second DC voltage is stopped through the DC voltage input terminal, the source mode operation may be stopped.

Meanwhile, the power circuit device may be configured to supply current corresponding to the second DC voltage to the internal battery in the case in which the second DC voltage is supplied through the DC voltage input terminal. Accordingly, the internal battery may be easily charged through the sink mode.

Meanwhile, the power controller may be configured to receive current of a first level, or receive current of a second level higher than the first level, from the battery device or the mobile terminal through the interface in the sink mode based on voltage information or current information of the battery device or the mobile terminal received through the interface. Accordingly, current of various levels may be received in the stand-by mode.

Meanwhile, the power circuit device may be configured to supply the current of the first level or the current of the second level from the interface to the internal battery in the sink mode. Accordingly, the internal battery may be charged based on the current of various levels in the sink mode.

Meanwhile, the power controller may be configured to supply current of a third level lower than the first level to the battery device or the mobile terminal through the interface in the source mode. Accordingly, it is possible to perform a source mode operation for supplying the DC voltage to the external battery device or the mobile terminal.

Meanwhile, the image display apparatus may further include a signal processing device configured to output an image signal to the display, and the interface may be configured to transmit the image signal received from the mobile terminal to the signal processing device or the power controller based on a display mode. Accordingly, the image signal received by the mobile terminal may be easily displayed in the display through the display mode.

Meanwhile, the interface may be configured to continuously transmit the image signal received from the mobile terminal to the signal processing device or the power controller in the case in which the second DC voltage is supplied through the DC voltage input terminal during operating in the display mode. Accordingly, although the second DC voltage is supplied through the DC voltage input terminal, the image signal received by the mobile terminal may be stably displayed in the display through the display mode.

Meanwhile, the interface may include a first port to receive the first DC voltage in the sink mode, or output the third DC voltage to the outside in the source mode, and a second port to receive the voltage information of the battery device or the mobile terminal. Accordingly, the source mode or sink mode operation is enabled through the interface.

Meanwhile, the image display apparatus according to an embodiment of the present disclosure may further include a load switch electrically connected to the first port, and the load switch may be turned off in the sink mode, and turned on in the source mode, and may be configured to supply the third DC voltage to the first port. Accordingly, in the source mode, the DC voltage may be stably supplied to the external battery device or the mobile terminal.

Meanwhile, the interface may be configured to supply the first DC voltage received through the first port to the power circuit device in the sink mode. Accordingly, the internal battery may be easily charged through the sink mode.

Meanwhile, the image display apparatus according to an embodiment of the present disclosure may further include a dc/dc converter electrically connected to the first port, and the dc/dc converter may be configured to decrease a level of the first DC voltage received through the first port, and supply the decreased DC voltage to the power controller. Accordingly, the power control may be stably operated based on the DC voltage from the external battery device or the mobile terminal.

Meanwhile, the image display apparatus according to an embodiment of the present disclosure may further include a signal processing device configured to output a mode change message in the case in which the second DC voltage is supplied through the DC voltage input terminal during the sink mode operation, and the power controller may be configured to switch the sink mode to the source mode based on the mode change message. Accordingly, it is possible to perform a source mode operation for supplying the DC voltage to the external battery device or the mobile terminal.

Meanwhile, the image display apparatus according to an embodiment of the present disclosure may further include a load switch electrically connected to the interface, and the power controller may be configured to supply the third DC voltage to the interface through the load switch by turning on the load switch based on the mode change message. Accordingly, it is possible to perform a source mode operation for supplying the DC voltage to the external battery device or the mobile terminal.

In accordance with another embodiment of the present disclosure, an image display apparatus includes: a display; an interface electrically connected to an external battery device or a mobile terminal; a power controller configured to control a source mode or a sink mode of the interface; and a DC voltage input terminal, and the power controller is configured to receive first DC voltage from the battery device or the mobile terminal through the interface in the sink mode, and stop the reception of the first DC voltage through the interface in the case in which second DC voltage is supplied through the DC voltage input terminal during operating in the sink mode, and supply third DC voltage to the battery device or the mobile terminal through the interface by switching the sink mode to the source mode. Accordingly, it is possible to perform a source mode operation for supplying the DC voltage to the external battery device or the mobile terminal.

Meanwhile, the image display apparatus according to another embodiment of the present disclosure may further include signal processing device configured to output a mode change message in the case in which the second DC voltage is supplied through the DC voltage input terminal during the sink mode operation, and the power controller may be configured to switch the sink mode to the source mode based on the mode change message. Accordingly, it is possible to perform a source mode operation for supplying the DC voltage to the external battery device or the mobile terminal.

Meanwhile, the image display apparatus according to another embodiment of the present disclosure may further include a load switch electrically connected to the interface, and the power controller may be configured to supply the third DC voltage to the interface through the load switch by turning on the load switch based on the mode change message. Accordingly, it is possible to perform a source mode operation for supplying the DC voltage to the external battery device or the mobile terminal.

Meanwhile, in accordance with yet another embodiment of the present disclosure, an image display apparatus includes: a display; an interface electrically connected to an external device; a power controller configured to determine an operation mode of a source mode, a sink mode, or a display mode in response to the external device being connected to the interface; a signal processing device configured to output an image signal to the display; a resistor between the power controller and the signal processing device; and a DC voltage input terminal, and in response to a DC voltage being supplied through the DC voltage input terminal, the power controller is configured to output a high-level signal to the resistor, and operate in the source mode based on the high-level signal. Accordingly, it is possible to perform a source mode operation for supplying the DC voltage to the external device.

Meanwhile, the power controller may be configured to control the interface to operate in the sink mode in response to the supply of the third DC voltage being stopped through the DC voltage input terminal while the interface operates in the source mode. Accordingly, it is possible to perform a sink mode operation for receiving the DC voltage from the external device.

While the preferred embodiments of the present disclosure have been illustrated and described above, the present disclosure is not limited to the aforementioned specific embodiments, various modifications may be made by a person with ordinary skill in the technical field to which the present disclosure pertains without departing from the subject matters of the present disclosure that are claimed in the claims, and these modifications should not be appreciated individually from the technical spirit or prospect of the present disclosure.

What is claimed is:

1. An image display apparatus comprising:
a display;
an interface electrically connectable to an external battery device or a mobile terminal;
a power controller configured to control the interface to operate in a source mode or a sink mode;
an internal battery; and
a power circuit device including a DC voltage input terminal, and configured to control the internal battery to be in a charging mode or a discharging mode,
wherein the power controller is further configured to:
receive a first DC voltage from the external battery device or the mobile terminal through the interface operating in the sink mode, based on DC voltage not being supplied through the DC voltage input terminal, and
supply a third DC voltage to the external battery device or the mobile terminal through the interface operating in the source mode, based on a second DC voltage being supplied through the DC voltage input terminal.

2. The image display apparatus of claim 1, wherein the power controller is further configured to stop the reception of the first DC voltage through the interface operating in the sink mode, based on the second DC voltage being supplied through the DC voltage input terminal.

3. The image display apparatus of claim 1, wherein the power controller is further configured to stop the supply of the third DC voltage through the interface operating in the source mode, based on the supply of the second DC voltage through the DC voltage input terminal being stopped.

4. The image display apparatus of claim 2, wherein the power circuit device is further configured to supply a current corresponding to the second DC voltage to the internal battery based on the second DC voltage being supplied through the DC voltage input terminal.

5. The image display apparatus of claim 1, wherein the power controller is further configured to receive a current of a first level, or receive a current of a second level higher than the first level, from the external battery device or the mobile terminal through the interface operating in the sink mode based on voltage information or current information of the external battery device or the mobile terminal received through the interface.

6. The image display apparatus of claim 5, wherein the power circuit device is further configured to supply the current of the first level or the current of the second level from the interface operating in the sink mode to the internal battery.

7. The image display apparatus of claim 5, wherein the power controller is further configured to supply a current of a third level lower than the first level to the external battery device or the mobile terminal through the interface operating in the source mode.

8. The image display apparatus of claim 1, further comprising:
a signal processing device,
wherein the interface is further configured to transmit an image signal received from the mobile terminal to the signal processing device or the power controller based on operating in a display mode, and
wherein the signal processing device is configured to output the image signal to the display.

9. The image display apparatus of claim 8, wherein the interface is further configured to continuously transmit the image signal received from the mobile terminal to the signal processing device or the power controller based on the second DC voltage being supplied through the DC voltage input terminal during the operating of the interface in the display mode.

10. The image display apparatus of claim 1, wherein the interface includes:
a first port configured to receive the first DC voltage while operating in the sink mode, or output the third DC voltage while operating in the source mode, and
a second port configured to receive voltage information of the external battery device or the mobile terminal.

11. The image display apparatus of claim 10, further comprising a load switch electrically connected to the first port,
wherein the load switch is turned off while the interface is operating in the sink mode, and turned on while the interface is operating in the source mode to supply the third DC voltage to the first port.

12. The image display apparatus of claim 10, wherein the interface is further configured to supply the first DC voltage received through the first port to the power circuit device while operating in the sink mode.

13. The image display apparatus of claim 10, further comprising a dc/dc converter electrically connected to the first port,
wherein the dc/dc converter is configured to decrease a level of the first DC voltage received through the first port, and supply the decreased DC voltage to the power controller.

14. The image display apparatus of claim 1, further comprising:
a signal processing device configured to output a mode change message based on the second DC voltage being supplied through the DC voltage input terminal during operation of the interface in the sink mode,
wherein the power controller is further configured to control the interface to switch from operating in the sink mode to operating in the source mode based on the mode change message.

15. The image display apparatus of claim 14, further comprising:
a load switch electrically connected to the interface,
wherein the power controller is further configured to supply the third DC voltage to the interface through the load switch based on the mode change message by turning on the load switch.

16. An image display apparatus comprising:
a display;
an interface electrically connectable to an external battery device or a mobile terminal;
a power controller configured to control the interface to operate in a source mode or a sink mode; and
a DC voltage input terminal,
wherein the power controller is further configured to:
receive a first DC voltage from the external battery device or the mobile terminal through the interface operating in the sink mode, and
stop the reception of the first DC voltage through the interface operating in the sink mode based on a second DC voltage being supplied through the DC voltage input terminal, and supply a third DC voltage to the external battery device or the mobile terminal through the interface by controlling the interface to switch from operating in the sink mode to operating in the source mode.

17. The image display apparatus of claim 16, further comprising:
a signal processing device configured to output a mode change message based on the second DC voltage being supplied through the DC voltage input terminal during operation of the interface in the sink mode,
wherein the power controller is further configured to control the interface to switch from operating in the sink mode to operating in the source mode based on the mode change message.

18. The image display apparatus of claim 17, further comprising a load switch electrically connected to the interface,
wherein the power controller is further configured to supply the third DC voltage to the interface through the load switch based on the mode change message by turning on the load switch.

19. An image display apparatus comprising:
a display;
an interface electrically connectable to an external device;
a power controller configured to determine the interface is operating in a source mode, a sink mode, or a display mode in response to the external device being connected to the interface;
a signal processing device configured to output an image signal to the display;
a resistor between the power controller and the signal processing device; and
a DC voltage input terminal,
wherein in response to a DC voltage being supplied through the DC voltage input terminal, the power controller is further configured to output a high-level signal to the resistor, and control the interface to operate in the source mode based on the high-level signal.

20. The image display apparatus of claim 19, wherein the power controller is further configured to control the interface to operate in the sink mode in response to the supply of the DC voltage through the DC voltage input terminal being stopped while the interface is operating in the source mode.
